(19) United States
(12) Patent Application Publication
(10) Pub. No.: US 2005/0096761 A1
(43) Pub. Date: May 5, 2005

(54) Golf score and information device and system

(76) Inventors: Michael D. Hanover JR., Columbus, OH (US); Jeffrey C. Fivecoat, Columbus, OH (US)

Correspondence Address: Sean M. Casey Co., L.P.A.;Attention: Sean M. Casey, P.O. Box 710, New Albany, OH, 43054-0710, US

(21) Appl. No.: 10/701,920

(22) Filed: Nov. 3, 2003

(51) Int. Cl. G06F 155/00

(52) U.S. Cl. 700/92

(57) ABSTRACT

A golf score and information device (100, 700, 900) that includes a portable electronic programmable processor and memory unit (110), display (120) and data entry assembly (130), and storage memory (117) operable to automatically or manually receive and send data via a communication circuit. The display (120) and data entry assembly (130) cooperate to visually present continuously scrollable information pertaining to any group of holes of a golf course in a representation of a golf score card. The device (100, 700, 900) is adapted to track current game scores, side games or competitions, hole-by-hole challenges, and to post the results manually and or automatically to a desired score collecting and processing authority.

### TECHNICAL FIELD

This invention relates to a golf scoring and information device that can be employed to record, post, and analyze golf scores and side game and competitive challenge parameters and results, and to display and communicate such information as well as related rules, statistics, and golf course information.

### BACKGROUND OF THE INVENTION

Associations, club owners, and golfers have long sought to improve present methods for tallying, tracking, analyzing, posting, authenticating golf scores, storing, and referencing handicap indices, course handicaps, and related statistics and parameters including the U.S. Golf Association Slope®, Course Rating®, and Handicap Index® of various courses.

What has long been needed in the art are improved methods for addressing the long-felt needs and continuing problems that persist in the use of manual, paper and pencil score cards, as well as in the tallying, recording, and posting of the scoring information contained thereon. Many attempts have been made in recent years to improve the state of the art and to implement more modern technology-based capabilities that can be used by golfers and golfing clubs and associations for purposes of facilitating improved and more accurate and convenient methods by which participants can record, communicate, and analyze personal golf game performance.

Other attempts have also been made to enable golfers to use their score and performance information for purposes of engaging in various types competitive and entertaining games with other players during golf rounds, which games are also referred to as side games that are tallied during and concurrent with the regular golf round statistics. Still more efforts have been expended to enable players to establish various golf game and score comparison capabilities that attempt to level the playing field by computing golfer-specific handicaps so that high-scoring, low-skill golfers can play against more skilled, low-score golfers.

Such handicaps are usually tied to the usual or average recent scores of a particular golfer and can take into account overall course and specific hole difficulties encountered during a round of golf. Some associations, including for example the U.S. Golf Association, have even gone so far as to establish highly-exacting handicap systems and mathematical formulas that purport to establish the most precise means by which different non-scratch golfers can be compared to one another for purposes of competitive play. So highly prized are such methods, systems, and formulas, that the U.S. Golf Association has even sought, obtained, and asserted trademark rights against others who attempt to use such formulas in contravention of the promulgated rules and procedures for “proper” handicapping.

In the face of such complexities, many such prior attempts to improve the state of the art have included efforts aimed at enabling the amateur golfer to retain control over his or her ability to play golf, have fun, and to improve their game by scoring, recording such scores, making computations using such scores for purposes of self-assessment by way of various handicapping systems, and for purposes of engaging in entertaining golf side games that can be based upon such handicapping methods and systems.

Of the many previous attempts at moving the state of the art forward, Bonito et al. in U.S. Pat. No. 5,127,044 has described an automatic golf scoring and scheduling system that is limited to, among other restrictions, mobile scoring and fixed handicap subsystems that exchange data to enable the golfer to keep score and to obtain course and hole parametric and pictorial information during play. The subsystems are also adapted to communicate such score data to a scoring central processing unit for collecting, processing, and reporting scores and for preparing handicapping computations. Various tee time scheduling capabilities are also included. Bonito et al. purport to describe new improvements to the art that include player specific wallet cards having magnetically stored player information, which is used at the clubhouse fixed system to prepare a portable data memory device to record scores. The card and the portable memory device are then carried onto the course, and preferably are connected to a scoring subsystem mounted in a golf cart. After play, the scores must then be transferred again to the portable memory device, which is then brought back to the fixed handicap subsystem at the club house. The Benito et al. devices and systems fail to advance that art in a way that accommodates the many other desirable capabilities now possible with present day technology. More specifically, while Benito et al. purport to improve the means by which player scores can be tallied, collecting, and processed, some have found that too many components, such as the wallet cards, portable memory devices, golf cart mounted scoring subsystems, and other components create too many possible failure points. Additionally, with so many components to maintain, it has been found to be a challenge at best to revise, update, and repair each of the components so as to ensure compatibility there between. Even further, Benito et al. fall short of offering any means by which individual golfers can engage in the many possible side games, which can greatly increase the entertainment value of the golf round for some players.

Other attempts at moving the state of the art forward have included manual handicap identification devices that enable golfers to establish course-specific and per hole handicap data. One such manual handicap device is taught by Gries et al. in U.S. Pat. No. 5,291,850, while another is described by Jones in U.S. Pat. No. 5,398,418. In the Gries et al. '850 device, prior art score cards are adapted and improved with various slidable rectangular and circular embodiments to enable quick-reference course, hole, and tee acceptable stroke assignment or concession information. More specifically, each course and each hole is assigned particular stroke and handicap identifiers on preprinted score and stroke assignment charts that players can employ during a round to give strokes to another player. In the Jones '418 devices, similarly capable circular or rectangular type slide rules are described that enable golfers to convert handicap indices into playing handicaps as a function of a respective course slope rating. Each of these manual devices, while offering certain quick-reference advantages, fail to offer the needed flexibility so much desired by players seeking to engage in various side games, and also fall short of minimizing the effort needed to accurately score, tally, report, and keep track of player performance during a round of play.

Another attempt of previous inventions includes the multimedia golf handicap interactive touch-screen system explained by Chartrand in U.S. Pat. No. 5,562,550, which is limited to a touch-screen manual data entry computer based device that requires, among other limitations, communication with an electronic card and card reader wherein the card is preprogrammed with player identification data. The Chartrand '550 device is also restricted to be used with card-bearing players who can use the card to authenticate themselves for purposes of permitting post-game manual score entry into the computer for processing, correcting, and reporting. As with previous attempts, Chartrand's '500 computer system offers little to players seeking to monitor and improve stroke-by-stroke play and game scores using various statistical parametric methods, and who seek to engage in various competitive side games and the like. In U.S. Pat. No. 6,074,312 to Lyon et al., another attempt similar to that of Chartrand is explained, which also uses an electronic golfer information card, but which is adapted to also receive and store some amount of the scores posted by the golfer for purposes of use at a particular golf course having a local processing unit adapted to receive the data on the card to compute the golfer's handicap index.

More portable and flexible electronic golf score cards have also been the subject of various improvement efforts and the electronic golf scorecard of Lambourne disclosed in U.S. Pat. No. 5,683,303 is yet another such attempt. Lamboume's '303 device is limited much like previous attempts to include only a basic golf stroke scoring capability that also purports to permit users to calculate handicaps. Among other limitations of the Lambourne '303 device, the display can only present and permit data entry to either the first or last 9 holes of an 18 hole course, and contemplates enabling players to track only minimal hole-by-hole performance statistics. Lambourne's device falls short in other respects as well in that it is not adapted to enable players to engage in even the most commonly entertaining side games, and it does not accept and display course and hole specific information that can be of great use to the players. Another similar device was disclosed by Nielsen in U.S. Pat. No. 6,162,129, and has many of the same shortcomings of other devices. The '129 Nielsen device is limited, among other restrictions, to a hand-held golf handicap calculator that uses a player supplied course index and slope to compute the player's handicap.

What has still eluded those seeking to improve the state of the art, is a golf scoring, performance tracking, and game assistant device that is easily adapted to the preferences of individual players and which can be employed by players everywhere without the need to be compatible for use with the electronics, computers, or software that may be in use at any particular golf course. Even further, it would be a significant improvement over prior art devices, including those described above, if additional features and capabilities could be incorporated so as to give even more capabilities to golf course proprietors, players, and other enthusiasts. More particularly, such an improved device and system should be capable of use with a wide variety of OEM and off-the-shelf hand-held devices and should be compatible for use with any number of pre-existing golf club or association scoring, processing, handicapping, and reporting system now in use. The present invention meets these and other needs and is widely compatible with existing hardware, software, and systems methods now in use as well as systems and methods that have been in use for many years prior to the current spate of electronic innovations. The instant invention accomplishes such achievements without adding any significant costs or increased difficulties to the game of golf, and without any added burdens in the areas of club, association, or player implementation or use.

### SUMMARY OF INVENTION

In its most general configuration, the present invention addresses the problems in the art and advances the state of the relevant technology with a variety of new features and capabilities that improve prior devices in new and novel ways. In one of the many preferable configurations, a golf score and information device and or system is disclosed that includes, among other features, capabilities, functions, and elements, a portable electronic programmable processor and memory unit having at least one information display and a data entry assembly. The display can be a display adapted only for viewing alone, and can also be adapted as a touch-screen type display that can display as well as accept data entry in addition to and in combination with the data entry assembly. A least one data and information communication circuit is also preferably included that can communicate data between the device and system. Further, at least one storage component is included that can receive information and program instructions, that can be programmed with functional capabilities, and that can be adapted to enable retrieval of such information and instructions.

Additionally, the display and the data entry assemblies are also further preferably or optionally adapted to cooperate to receive data and information and to visually and incrementally and continuously scrollably present information pertaining to any group of a plurality of holes of a golf course in a facsimile representation of a golf score card for the course. The display is also adapted to present and continuously and or incrementally scroll through and display various other forms of information that can include text, graphics, images, moving images, video, and the like. Further, the processor and memory unit may also be programmed to manipulate a plurality of items of the instructions and or information that can include, for purposes of example, at least one set of golf course data including a slope and a course rating, rules for golf and any number of the possible side games and challenges that are now known and that may be established in the future. Further, at least two sets of golfer data can be received and retrieved from the processor and memory unit that may also further include at least one golf game score for a plurality of holes as well as a handicap index and a scoring record, among many other possible items that can include, for purposes of example without limitation, a table of points by hole by golfer for various side games and challenges, and a scoring record for each golfer.

The various embodiments of the instant invention may also further include modifications wherein the at least one communication circuit is adapted to selectively and automatically send and receive one or more data items of the plurality of scrollable information respectively to and from another golf score and information device, as well as any number of other scoring and information systems that can include, for purposes of example, desk top and notebook type computers, kiosk type devices often found at some golf clubs and courses, personal data assistant devices, and official and unofficial scoring, analysis, and reporting systems of golf courses and club, associations, and other entities of interest.

In variations of any of the contemplated embodiments of the invention, the golf score and information device can be and or include the portable electronic programmable processor and memory unit to be a handheld portable data assistant and or comparably capable devices and components of such devices. In yet other variations, the processor and memory unit are more preferably further programmed to periodically and automatically initiate a save point procedure that stores entered information into a non-volatile memory storage component to prevent data loss during accidental or timed power off sequences as well as during low power or drained battery events.

In further variations, the golf score and information device may be further optionally modified whereby the portable electronic programmable processor and memory unit are adapted or programmed to incorporate a unique security key code that can be used so that golf score and information device can be restricted in its capability to only communicate, via the at least one communication circuit, with another predesignated golf score and information device that can authenticate the unique security key. In still other possibly preferred variations of the preceding embodiments, the inventive golf score and information device is further adapted so that the unique security key is a resettable hardware component of the golf score and information device that can be reset directly and remotely over the internet by the manufacturer, the user, the owner, and or by another specially equipped entity such as a golf club that may periodically implement new codes to ensure authenticity of scores reported by those using the device and system. In other alternative configurations, the golf score and information device may be further modified to have the unique security key to be a resettable software component of the golf score and information device. In any of such preferred or modified versions of the various embodiments of the invention, the unique security key can be created to authentically identify a predetermined user or owner of the golf score and information device and system, or an individual for whom a score is entered into, stored within, and reported from the device and system. The various embodiments of the invention may also be further preferably or optionally modified wherein the processor and memory unit are programmed to process the course rating and the slope rating and the handicap index to establish a true U.S. Golf Association handicap and or an estimated player handicap and a running golf game score.

In any of the many possible physical configurations of the preferred golf score and information device and system according to the principles of the invention, the device and system may formed to be attached to a golf score card retainer of a golf cart or golf bag, in an embodiment that incorporates at least one grip clip that is formed with at least one ridge adapted to interlock with one or more elements of the retainer of the golf cart or golf bag. In this way, the inventive golf score and information device and system can be retained in any of the many legacy golf score card holders and retainers now known and in use as well as those that may come into existence in the future.

Any of the various possible embodiments of the inventive golf score and information device and system can also be further modified to assist golfers with improving their skill level whereby the device and system is configured to receive, store, retrieve, and display any number of possible skill improvement information that be selected from a knowledge base and or database of player specific and more general critiques, recommendations, suggestions, and tips that can be manually retrieved and or automatically displayed before or after a round of golf, before and during play of all or specified holes in the round, or at other times. The skill improvement information, even in its more generic general form, can be filtered and displayed in the context of specific inquires by a player as well as in a more automated way that displays such information in the context of the skill level of the player, the type of shot presented to the player, the particular hole of a golf course, and in any combination thereof. In further, even more capable variations of any of the preceding embodiments, the inventive device and system may also further be configured to receive such skill improvement information from another system based upon an analysis of the performance statistics of a particular player.

These variations, modifications, and alterations of the various preferred embodiments may be used either alone or in combination with one another as can be better understood by those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals, and like numerals with primes, across the several drawings, figures, and views refer to identical, corresponding, or equivalent elements, components, functions, operational capabilities, features, and parts:

FIG. 1 is a front plan view, in modified scale, of one schematic representation of an embodiment of a golf score and information device and system according to the principles of the instant invention;

FIGS. 2A, 2B, and 2C are together an operational flow chart that describes various aspects of the device and system of FIG. 1;

FIGS. 3 through 26 are diagrammatic and illustrative representations of various display screens that correspond to various data entry, data display, and operational and functional capabilities illustrated in FIGS. 2A, 2B, and 2C, and as described herein, of the device of FIG. 1;

FIG. 27 is front plan view, in modified scale, of an alternative embodiment of the golf score and information device according to the principles of the instant invention;

FIG. 28 is a side view, rotated and in modified scale, of the golf score and information device of FIG. 27;

FIG. 29 is a reverse view, rotated and in modified scale, of the golf score and information device of FIG. 27;

FIG. 30 is a plan view, in a scale modified from that of FIG. 27, of a protective carrying and storage case adapted to receive and carry the golf score and information device of FIG. 27;

FIG. 31 is a side view, in modified scale and rotated, of the protective carrying and storage case of FIG. 30;

FIG. 32 is a generally topside plan view, in modified scale, of another alternative embodiment of the golf score and information device of the instant invention;

FIG. 33 is a plan view, in modified scale and with certain structure arranged in a different orientation for illustration purposes, of the golf score and information device of FIG. 32;

FIG. 34 is a generally underside plan view, in modified scale, of the golf score and information device of FIG. 32; and

FIGS. 35 and 36 are diagrammatic exemplary circuit schematics that illustrate various additional features and capabilities of any of the embodiments of the inventive golf score and information device of the instant invention.

Also, in the various figures and drawings, various reference symbols and letters may be used to identify significant features, dimensions, objects, and arrangements of elements described herein below in connection with the several figures and illustrations.

### DETAILED DESCRIPTION OF THE INVENTION

In a wide range of possible embodiments and modifications and variations thereof, the golf score and information device according to the features and capabilities of the instant new and novel configurations of the invention establishes new and heretofore unavailable solutions to the many problems attendant to tracking, communicating, and analyzing golf scores and player performance, golf course data, and for accessing and referring to the many golf and side game rules and regulations. The golf score and information device embodiments and configurations that are contemplated herein have broadly encompassing utility in the golf industry and are compatible for use with all known scoring methods and systems, and with any of the wide range of long-established golf games and related score posting and tracking regulations and procedures, as well as with yet unknown systems for scoring, tracking, posting, communicating, and referencing such scores and information. The contemplated inventive score and information device can be configured and programmed to meet an unlimited array of golfer preferences, and can be adapted to meet the official and unofficial scoring, posting, handicapping, and attestation requirements of various associations, clubs, and their promulgated rules and requirements, as is further described in herein elsewhere. The improved simplicity and efficiency of operation and use and the new features and capabilities of the golf score and information device and systems described herein establish a new standard in such devices and methods that will serve to significantly reduce the probability of error and that will vastly increase the ease with which players of differing skill capabilities can compete on a level playing field so as to thereby be able to more readily enjoy the game of golf.

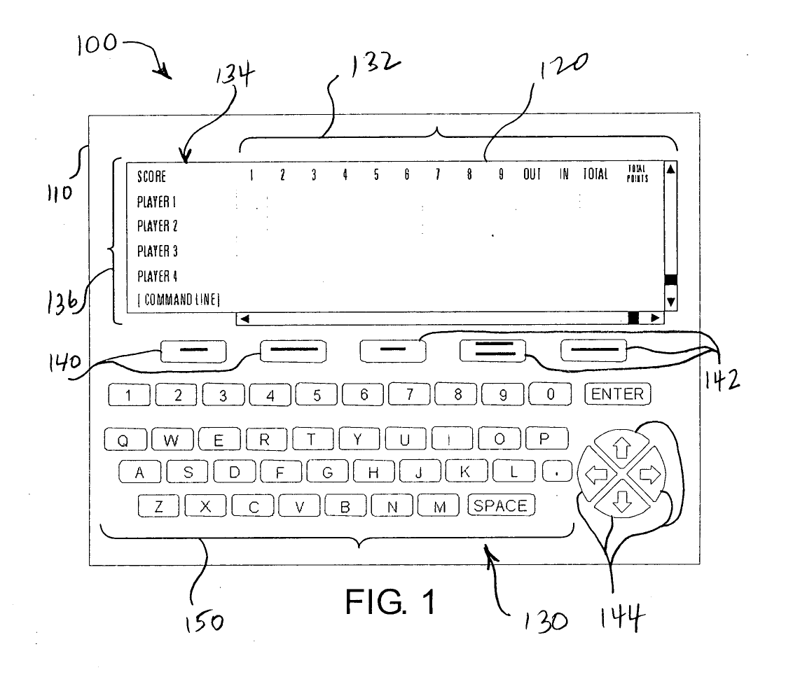

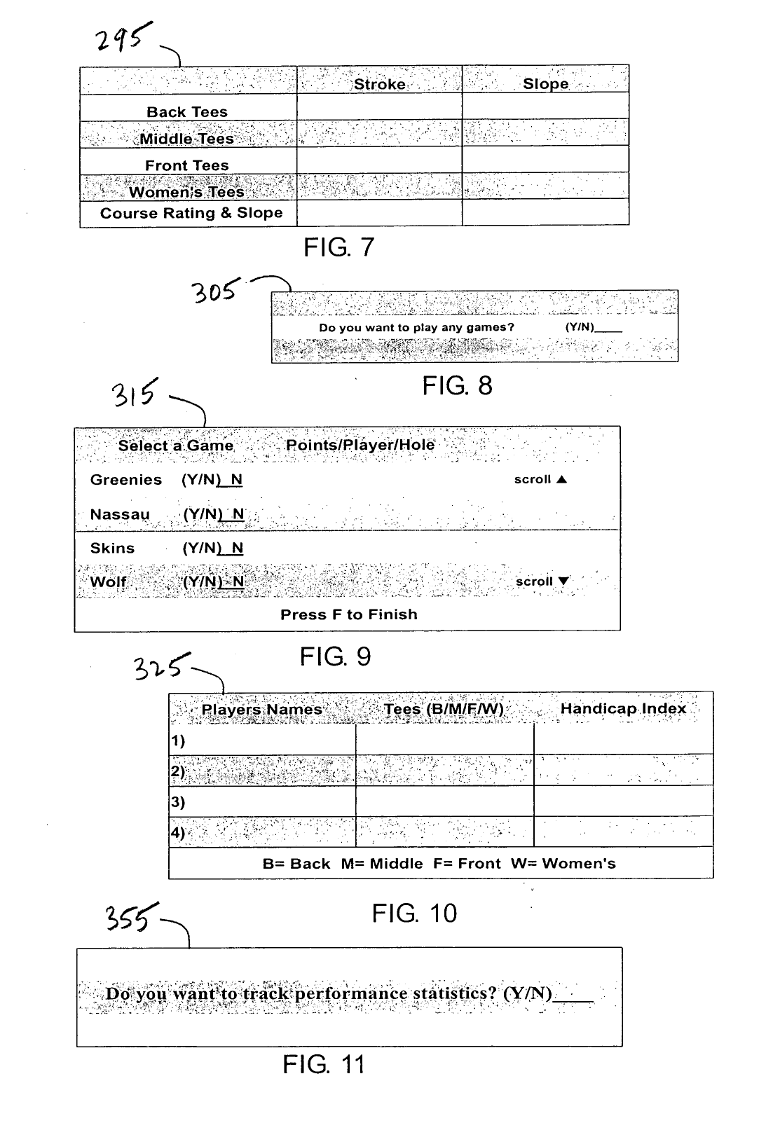

With reference now to the various figures and particularly to FIGS. 1, 2A, 2B, 2C, and 3 through 26, a golf score and information device and system 100 is depicted in a hardware configuration and embodiment that is readily adapted for use in any of the widely used golf cart scoring accessories that enable attachment of score cards and the like on the steering wheel of the cart and on other places therein, and in other equally suitable configurations that can include bag mounted holders, and other means for releasably mounting and retaining the device and system 100. One of many possible embodiments of the instant invention can include the device and system 100 being configured to be incorporated with and to function as and replace and or to take the place of the customary club member bag placards and identification insignia and tags.

Although shown herein across the various figures as being configured in various contemplated embodiments for mounting on and in connection with presently available golf bag and cart type mounting accessory hardware, the instant invention is also contemplated for implementation in any of many other desirable hardware configurations that include, for further purposes of illustration but not for limitation, portable pocket-type devices and various personal data assistant (“PDA”) type handheld devices such as Palm® Tungstens® and Zires® and Pilots®, Handspring® Treos® and Visors®, Hewlett-Packard Jornadas® and iPaqs®, and similarly capable electronic PDA-type and hand-held computer-type data devices, including notebook and laptop computers, any of which can be adapted with software and firmware encoded with programs devised according to the principles of the instant invention.

More specifically and with continued reference to the various figures and especially to FIG. 1, the contemplated inventive golf score and information device and system 100 includes, among other features and components, a portable electronic programmable processor and storage memory unit 110 that includes at least one display 120 and data entry assembly 130. The device 100 is also configured with at least one communication circuit (described in more detail in connection with subsequent figures) for communication of data external to the device and system 100. The display 120 and data entry assembly 130 is adapted to visually present a plurality of continuously or incrementally and generally horizontally and vertically scrollable information pertaining to any group of a plurality of holes 132 of a golf course, and players 136 or other list of information such past hole performance statistics, in a facsimile representation 134 of a golf score card for the course of interest. players 136 or other list of information such past hole performance statistics. Such scrolling capability is optionally implemented in any number of ways that can include scrolling of such information row by row, column by column, character by character, pixel by pixel, in groups thereof, and in any preset or reprogrammable or selectable incremental group thereof so as to maximize user convenience.

Although not shown in the various figures, the display 120 is also preferably or optionally adapted to visually present color and or grayscale imagery related to the course to be played that may be helpful to players during a round. Additionally, the display may be further configured to present graphical representations of statistical performance data and other information suitable for such graphical representations, as well as any conceivable form of information and graphics that can be in the form of encoded alphanumeric and symbolic information, graphics, images, moving images, video, and other forms of text and graphics.

The device and system 100 are adapted where by the processor and memory unit 110 is re-configurably programmed to manipulate and communicate a plurality of items of the scrollable information that can include such manipulations and operations as accepting manually entered data, as well as receiving, storing, retrieving, displaying, scrolling through, analyzing, processing, executing program routines and steps, updating, computing, transmitting and receiving to other internal and external devices, and otherwise performing various actions on and in connection with such data. Although not reflected in the various figures, and although referred to here in the singular sense, the instant invention contemplates and is directed to embodiments that incorporate and that can be augmented with additional processor and memory components for added or expanded functionality, storage capability, communications capabilities, internal and external system and data backup capabilities, and expanded functions that can include, for purposes of example without limitation, data uploading, downloading, and synchronization with other devices and computers, including a user's desktop computer and any other computer system and or database used for score posting, data exchange, post-round skill assessment, analysis, and tallying and reporting of scores and game and challenge points.

Other equally useful functions for which the inventive device and system 100 is also configured include even more capable functions such as, for purposes of further illustration, upload of data to a club or association computer server that is used for large scale score posting, analysis, and tracking; and for real-time communication capabilities for receiving and transmitting hole scoring, and for competition and challenge scoring information during a round for centralized and individual viewing by players playing in a tournament at one course, at multiple courses, and or at different time intervals on one or multiple courses, and many possible combinations thereof. In this way, as a further example, players can compare their performance on a particular hole of a particular course at any point in time during a tournament to the performance of others who have already played that particular hole, even if those other players may have played that hole 7 at a different time.

For purposes of explicating yet another illustrative example, during the course of a tournament that may span several weeks and several different golf courses, any player can use these features and capabilities of the instant invention to also assess and compare their own performance to that of others in the tourney overall even though the players in a tourney may play the various courses in a different sequence. Such multi-course, multi-day, and or multi-month tourney capabilities can be employed either in the context of professional, amateur, or personal and less formalized structures without any added burden or difficulty for the players burdened with having to tally scores. These capabilities enable heretofore unavailable tournament, side game, and challenge score keeping capabilities wherein a tournament can be established with any number and combination of players, geographically distant courses, and side games and challenges, whereby players may play multiple courses over the duration of the tournament across extended periods of time without unusually onerous score keeping burdens.

In any of its many possible and contemplated embodiments, the preferred device and system 100 also contemplates various features that can be implemented on the data entry assembly 130, which for purposes of example without limitation can include various specialized, programmable, and reprogrammable function keys 140, 142, 144 that can actuate various capabilities of the device 100 including quick reference informational displays, direct menu item access (i.e. quick access to golf score data entry, analysis, and viewing screens without the need to navigate about and through multiple and tiered menus of options), and screen scrolling capabilities, to name a few possibilities. As can be appreciated by those having requisite skill in the relevant arts, such specialized and programmable function keys 140, 142, 144 can be optionally or preferably reconfigurable and reprogrammable by users who may desire to optionally or preferably accept default function and capability assignments for each of such specialized and programmable function keys 140, 142, 144 or to assign their preferred configuration(s). Further, the user may also reprogram, redesignate, reconfigure, and reassign such specialized and programmable function keys 140, 142, 144 to operate alone or combination with one another and other keyboard elements such as keyboard elements 150 in any number of other optional or preferable ways that can include enabling direct access to various menu items and specialized functions and capabilities of the inventive device and system 100. It can be further appreciated that such other keyboard elements 150 can be similarly reprogrammed, redesignated, reconfigured, and reassigned. When such specialized and programmable function keys 140, 142, 144 and or data entry keyboard elements 150 are enabled in either default or user selected adaptations and reconfigurations, such keys and elements 140, 142, 144, 150 can operate much like the shift, alternate, Windows®, and control keys, which are often annotated on many computer industry standard computer keyboards as “Shft,” “Alt,”, “Win,” and “Ctrl,” which keys are used to enter data and to enable uppercase and lowercase alphabet characters, special symbols, and various software operations, functions, and capabilities that correspond to predesignated or user selected keyboard keystroke combinations.

Additionally, the data entry assembly 130 can also incorporate traditionally alpha numeric data entry keyboard elements 150 having any desired layout and arrangement and can be configured in one particular such arrangement in what is commonly referred to as a “QWERTY” style keyboard (which refers to the most-commonly employed, industry-standard roman alphabet-type alphanumeric keyboard layout wherein the upper-left alpha keys are arranged in the order “Q-W-E-R-T-Y”), as well as various types of other less cluttered keypad designs, such as the numeric and alphanumeric layout and configuration of many types of telephone keypads, as is further illustrated in connection with other embodiments described elsewhere herein. Other languages and character-sets have similar arrangement and layout conventions that are also contemplated for use with the embodiments of the instant invention. In yet other alternative variations of any of the embodiments herein, such capabilities of the data entry assembly 130 can also be augmented with various touch screen data entry features that are known to those skilled in the art, wherein the user or golfer can either navigate through the various features and capabilities of the contemplated device and system by touching the screen of the display 120 as well as by entering data by writing characters on the display 120 as one would form such characters with a pencil and paper, as well as by touching or actuating various iconic elements and designated screen positions to activate functions that are otherwise accessible via any of the data entry assembly 130 elements and menu configurations already described and contemplated hereby.

Additionally, such touch screen capabilities can also further incorporate facsimile keyboard and key pad layouts displayed on the screen of the display 120 to represent any desired arrangement and payout of keys whereby tapping the key representing a desired character operates to enter that character in the data entry assembly 130 of the device and system 100.

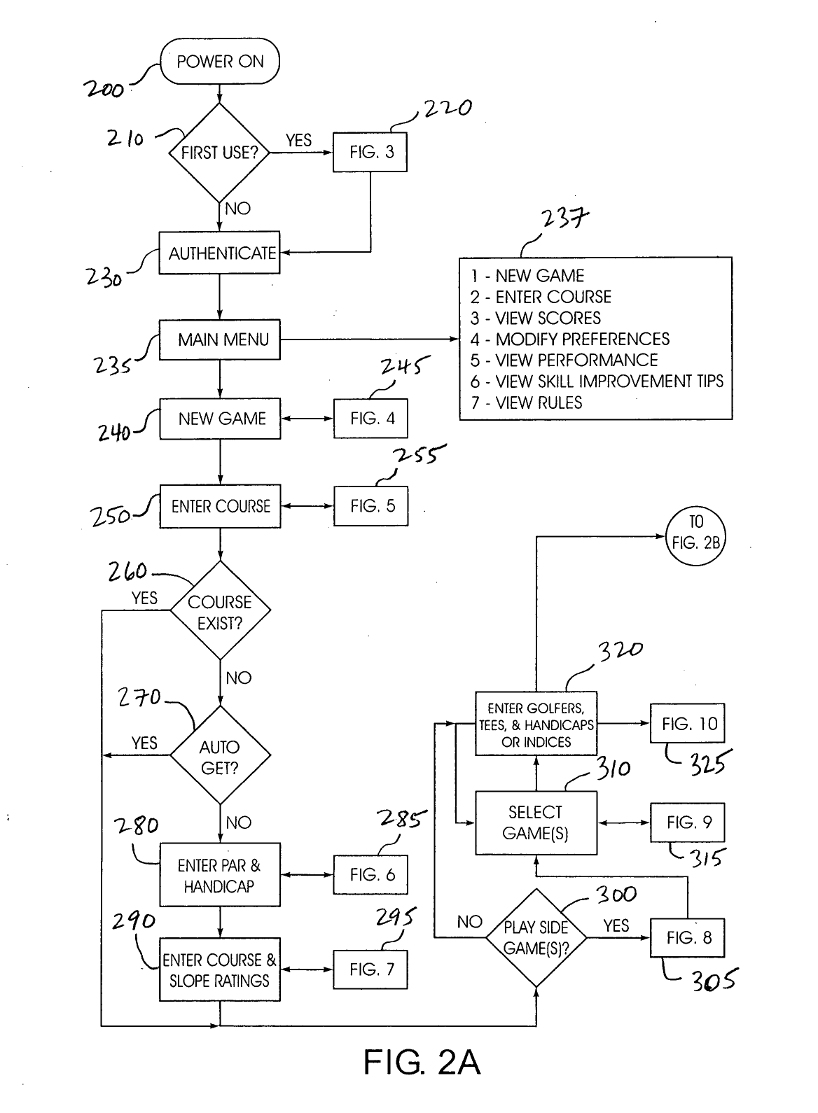

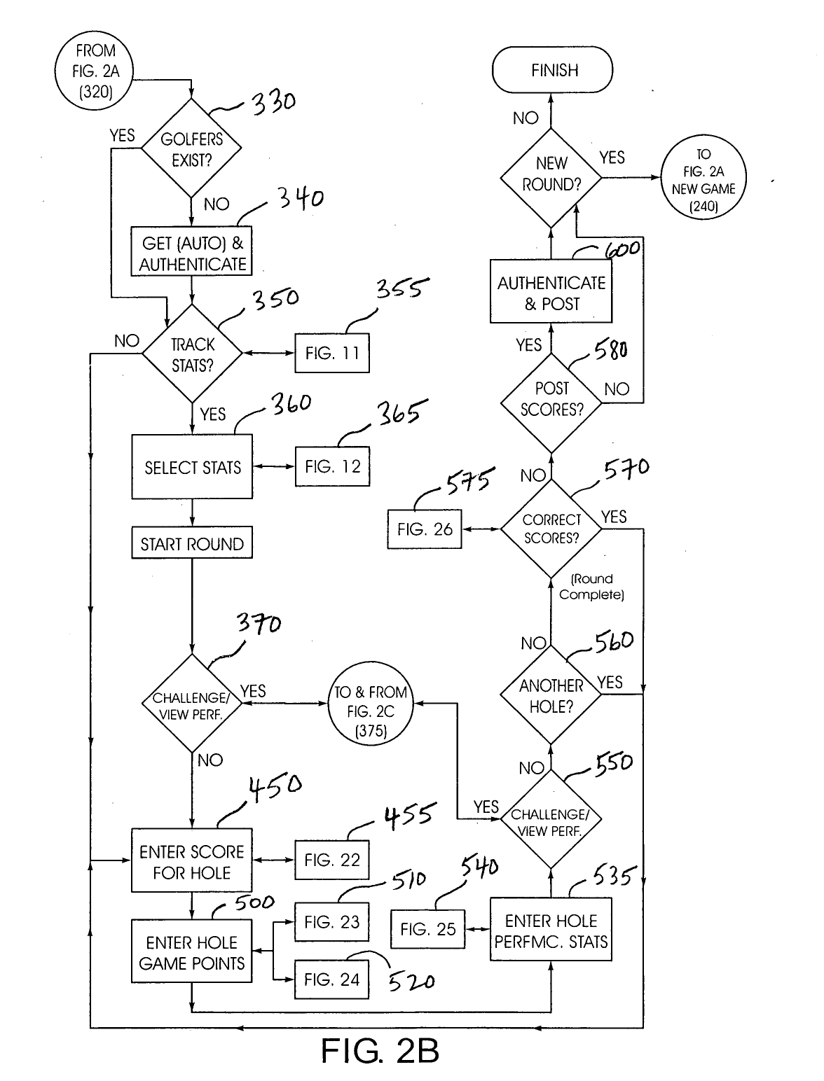

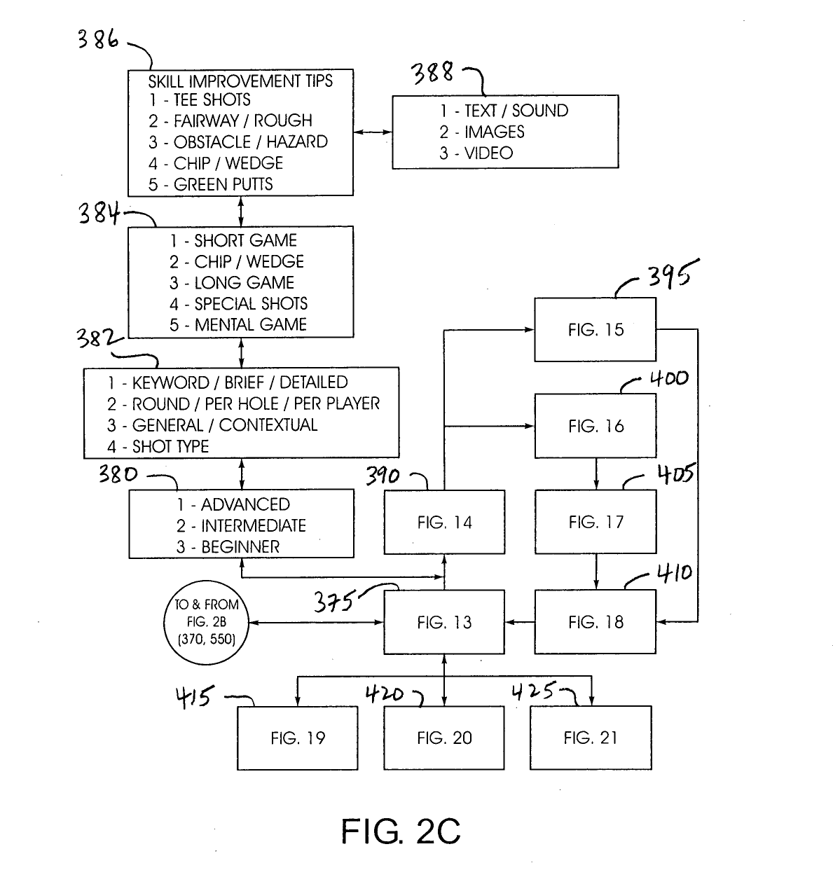

With continued reference to FIG. 1 and reference now also to FIGS. 2A, 2B, 2C, and 3 through 16, those skilled in the art may come to comprehend various additional features, elements, and capabilities of the new and inventive device and system of the present invention.

In FIGS. 2A, 2B, and 2C, a schematic flow diagram is depicted that identifies major categories of the functional aspects of the inventive device and system 100. In operation, the device and system 100 is first initialized at step 200 (FIG. 2A) by energizing the power supply to the device and system 100. This is done by actuating any of and or any predetermined combination of the keyboard keys, including for example, any of the noted function keys, 140, 142, 144 or keyboard elements 150, any one or more of such keys and elements can be a dedicated and or reprogrammable power-on-power-off or system reboot-reset button. When a touch screen capability is incorporated into the display 120, then any portion or predesignated portion of the screen may also be adapted to initiate the energization function. Once the device and system 100 is in the powered on state, the device and system 100 is further configured to execute hardware and software initialization instructions and routines that enable the various features and capabilities of the invention. Such instructions and routines can be configured to setup the device and system 100 for initial or first-time use, to display the last displayed screen, which can be a current active golf round score entry screen, or which can be a display screen for a new round of golf and or a display for the last round score and performance data, or a host of other possibly desirable display screens of information. The device and system 100 can be further configured wherein a save point capability as described elsewhere herein is employed to enable a power on preference that automatically directs the user to the last viewed screen so as to establish a power-on state of the device and system 100 that is identical to or equivalent to the last state of the device and system 100 prior to power-off, which can greatly improve the convenience to the user. This convenient configuration is especially pronounced in circumstances where the device and system 100 may lose power due to exhausted batteries, and where the device and system 100 is inadvertently turned off, or when the device and system powers off due to expiration of a predetermined time period established to conserve battery power during non-use, to name a few exemplary circumstances.

Once powered on, the device and system 100 commences a sequence of pre-programmed, and re-programmable routines, functions, sequences, and or algorithms, wherein the first step thereof queries an internal memory location to ascertain the last known operational state of the device and system 100 established by the data preserved at the most recent state save point. If the internal memory establishes that the device 100 has not been previously initialized, i.e. the device and system 100 is either newly “out of the box” from the factory or has been re-initialized to its original factory settings, then the sequence proceeds to display a screen such as screen 220 that can be configured to instruct the golfer to enter various data items such as, for purposes of example without limitation, date and time, the name of the owner and or primary golfer of the device and system 100, the golfer or player name identifier, a player or golfer or device 100 unique identifier, a password for the user or users of the device, and a handicap index for the primary player or golfer and other individuals to be entered into the device and system 100. Although the unit 100 is configured to enable entry of all such data through the data entry assembly 130, even more preferably, all such data can be programmed into the device and system 100 prior to actual use via the communication circuit in any number of possible ways.

Many other possible data items are contemplated for use with the instant invention and the preceding items are only for purposes of example. The contemplated golfer or player name unique identifier can be a GHIN and or member number issued by the golfer's primary association or club, or any other of a host of other possible alphanumeric or symbolic identifiers. The GHIN number is obtained from American service of the U.S. Golf Association handicap service organization, which created the acronym from its entity name: Golf Handicap Information Network. The unique identifier can also any other preferred identification indicia and or number and can be an additional number that may be assigned to the device or system 100 by the manufacturer, an issuing association, club, or other organization. In the various embodiments of the instant invention that enable automated and electronic posting of scores and tournament and player information, such unique identifying numbers can be controlled to enable score keeping, tallying, and handicap issuing authorities to authenticate scores and to control the issuance of authoritative and authenticated handicaps in a way that also enables the more precise identification of the respective individual, player, association, club, or other organization posting a score, as well as the means by which to identify which precise user, device, and system logged and posted the score and or received and obtained the resulting authenticated handicap(s).

One of the many shortcomings of the prior art has been evidenced by the inability of previous devices to successfully enable the entry, capture, storage, and retention of the official score data being entered by the golfer or other user. More specifically, during such previously described initialization steps 210, 220, as well as during play and entry of competition, challenge, and performance statistical data, users have often complained that data is often lost when power is interrupted. One of the many improved and useful features of the instant invention includes the capability to monitor data entered by the user and to automatically and periodically save that data to the internal non-volatile memory of the portable electronic programmable processor and storage memory unit 110. This can be a capability that is pre-programmed at the factory before sale and distribution and can also be a feature that is selected and modified by the user or golfer during setup of various preferences or preferred default and selectable and reconfigurable preferred parameters of the inventive system and device 100, as well as by later implementation by user installation of expansion options that can expand or enable such functionality after initial purchase and setup.

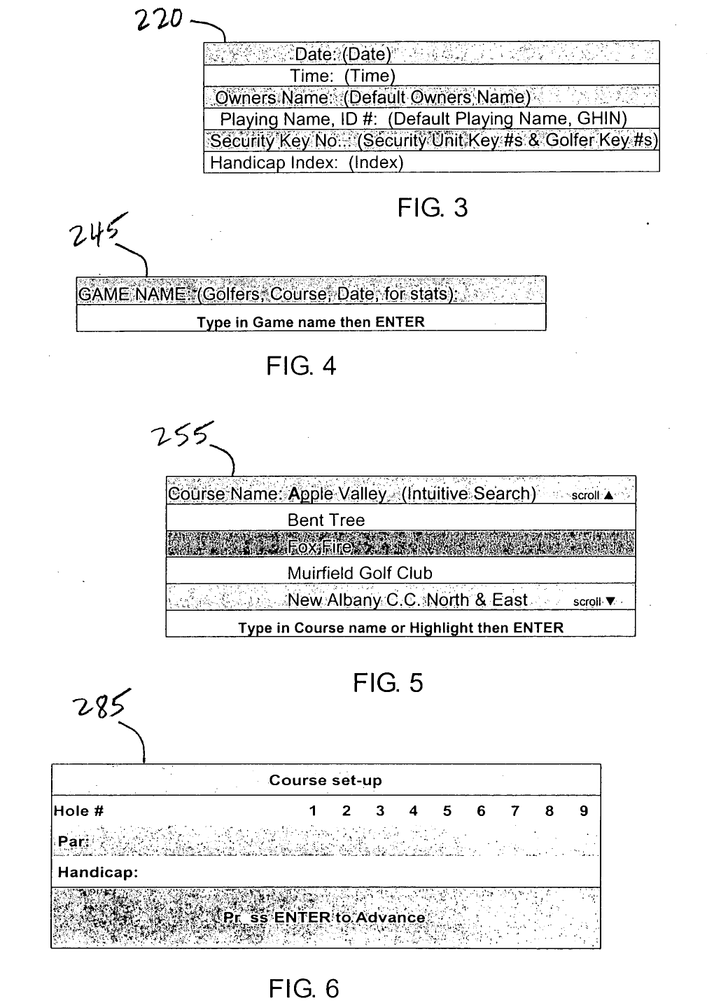

The inventive capability has been termed here to be the save point capability, which in short, ensures that data entered is stored to non-volatile memory periodically and after entry of various data items and or after a chosen period of time has elapsed. That is, the device and system 100 is programmably configured to have multi-elapsed-second save points and or to have other types of periodic save points built into the many sequences and steps of operation illustrated herein so that data loss is minimized if not completely prevented. More particularly, it has been found to be especially preferable that the data being entered by the user or golfer is saved every several seconds so that nearly every keystroke is preserved in the event that the power is interrupted to the device and system 100, or in the circumstance where the unit 100 is subjected to inadvertent maniputlation. It has also been found to be preferable to have a save point capability that saves data entered after the user or golfer moves from step to step in the many sequences of operation of the inventive system and device 100. This save point capability can operate after the user or golfer moves from one line of a screen such as screen 220 of FIG. 3, and also after a user moves from any one screen to another. Such save point capabilities, whether invoked at elapsed second intervals, or at line-to-line or screen-to-screen intervals, have been found to be especially useful and desirable in that data is now rarely lost, which results in more efficient scoring as well as greatly diminished user and golfer frustration.

Once the device and system 100 is initialized with data for at least the primary golfer or player, then the device 100 can proceed to an authentication sequence step 230 wherein the user is prompted to enter any of the noted unique player or device identifiers or the password for the device 100 as needed. Whether or not the authentication sequence step 230 is employed, enabled, or otherwise executed, the device and system 100 may also incorporate a master or main menu display and step 235 that can incorporate direct and convenient instant access to menu items, such as menu items 237 (FIG. 2A). Such menus may be user reprogrammable and selectable and can be configured to bypass other steps or functions so as to further improve convenience of use tailored to the personal preferences of the individual.

Proceeding to another possibly preferred step 240 in the sequence, the golfer can then be prompted with a screen 245 to enter a name for the game to be played, which can be “US PGA Open Round 1” or “Ernie and Sam, 10-21-2004” or any other preferred round identifier that is desired. Here again, although the sequence of steps is illustrated in one particular order, any number of equally effective, optional, or user reprogrammable sequences of such steps are similarly preferred for use in any of the various embodiments of the device and system 100. This round identification information can also be automatically generated by the device 100 to include the current date and time, a sequential round serial number, and any other preferred information that can be concatenated and displayed as part of the round identifier for editing and or acceptance by the golfer.

Although any possible order of the proposed sequence of steps depicted here can be equally preferred, after initialization 210, authentication 230, and naming of the prospective round to be played 240, the user or golfer next may next be prompted at step 250 with a screen such as screen 255 to identify the course to be played for the round. The screen 255 can be configured to present course data retrieved from the internal memory 110 of the device and system 100 that can include preprogrammed or entered course information such as course name, course and slope rating, and various other hole-by-hole par and handicap data, as well as various course related information that can include possible tee shot positions, hole imagery, hazard and obstacle details and yardage.

While the instant invention contemplates such data can be retrieved from its internal memory 110, the unit 100 is also adapted to retrieve such course related information from the many types of other electronic scoring devices and data resources that have the capability to transmit information, as well as from the club, course, internet, and association databases that are also widely available in electronic form. As described in more detail below, the device and system 100 may also be adapted with various communications capabilities to accommodate such additional retrieval methods. It can also be understood that the inventive system and device 100 can be adapted to transmit and receive information via cable-based and wireless serial, parallel, and network data interface circuits, and through infrared transceivers, and other methods.

In the instance where a new course is to be played, the user or golfer is prompted at step 250 to ascertain whether the course to be played exists in the memory 110 of the device and system 100. If so, then the sequence proceeds from step 260 to step 300. If the course to be played is not stored in the system and device 110 then the user is prompted at sequence step 270 to automatically retrieve or to manually enter the course data. If manual entry is needed, then the sequence proceeds to steps 280 (screen 285) and step 290 (screen 295) whereon the user or golfer may enter the various course hole-specific data in a variety of possible screen arrangements.

Once course data has been selected from the list or stored for use in scoring the current round, the golfer may next be prompted at step 300 with a prompt such as 305 to ascertain whether points for any side games are to be tallied in conjunction with the round. At this step, the device and system 100 is adapted whereby unit 110 can further prompt the golfer at step 310 with a scrollable screen such as screen 315 that can list side games that have already been programmed into the memory 110 of the system and device 100. While many such games are known to and enjoyed by golfers around the world, for purposes of example without limitation, some preferred games include Greenies, Wolf, Nassau, Skins, Bingo-Bango-Bongo, and modifications thereof, and others noted elsewhere herein.

Here again, although the proposed sequence of steps can be altered as preferred, the next possible step of the inventive system and device 100 may include precise identification of the golfers or players participating in the round. Although the instant invention contemplates use with a single player, the system and device 100 is also adapted to be used to tally and store hole and round scores, side game and challenge points, and other round performance statistics for a plurality of 2, 3, 4, 5, or more players. Also, as noted in more detail below, the inventive device and system can be used to score and tally such data for automated posting at the respective club, association, or other entity using any of the contemplated means for authentication noted herein.

Thus, those having skill in the art may further observe that at step 320 a screen 325 can be displayed to prompt for the respective player and golfer names, tees (back, middle, front, women's) from which the player will tee-off, and handicaps, indices, and the like. Also, for scoring and posting authenticated rounds, the device and system 100 can be further adapted to maintain a database in its memory 110 of known golfers at step 330 and to authenticate each such golfer at step 340 with his or her respective unique identifier, GHIN or member number, password, security identifier, unique security key or code, and similar data that can be authenticated and identified to a specific golfer. Further, if such additional golfers whose scores are to be tallied and authenticated are not already contained in the memory 110, then the names and any unique authenticating identifiers can be manually entered and or automatically communicated and stored into the memory 110.

All of such player specific data as well as various player-specific preferences may be preferably or optionally stored for any of the stored players. Additionally, such player preferences are also optionally or preferably stored as a set of player specific, round specific, and device and system specific parameters and preferences, which are maintained to be retrieved any time such a stored player plays a round to be scored on the respective device and system 100. Such stored preferences may also preferably include various player side game, competition, and challenge parameters and preferences as may be desired. In any of the possibly preferred and optional modifications of the device and system 100, the unit 100 is further configurable whereby the stored parameters and preferences may be automatically retrieved for use during scoring of a new round of golf so as to minimize the time needed to prepare the unit 100 for use.

More specifically, once such information has been configured and stored in the device and system 100, the individual responsible for keeping score may simply turn on the power, select the participating players, and proceed to play the round. Although user reconfigurable, the device and system 100 will preferably automatically by default retrieve, adopt, and apply the player, round, and or device 100 parameters and preferences previously established. Also, the device and system 100 is adaptable to prompt the user to accept default or previously stored parameters and preferences, or to enable modification thereof.

The device and system 100 is also adapted to receive, be programmed with, and or retain in its processor and memory unit 110 a unique security key that can be programmed into the device and system 100 at the factory, or programmed into the computer software programmed therein in a way that cannot be changed, which is often referred to in the industry as “hard-wiring” the code into the device and system 100. In this way, each such device and system 100 can be uniquely identified with an electronic serial number that can be useful for warranty service, upgrades, and for the noted authentication purposes. Also, the unique identifier or security key for the primary player or owner of the device and system 100 as well as those identifiers or keys for other players maintained in the device and system can be similarly hard-wired into the physical memory of the unit 110 or the computer readable software stored therein in permanent and reconfigurable arangements.

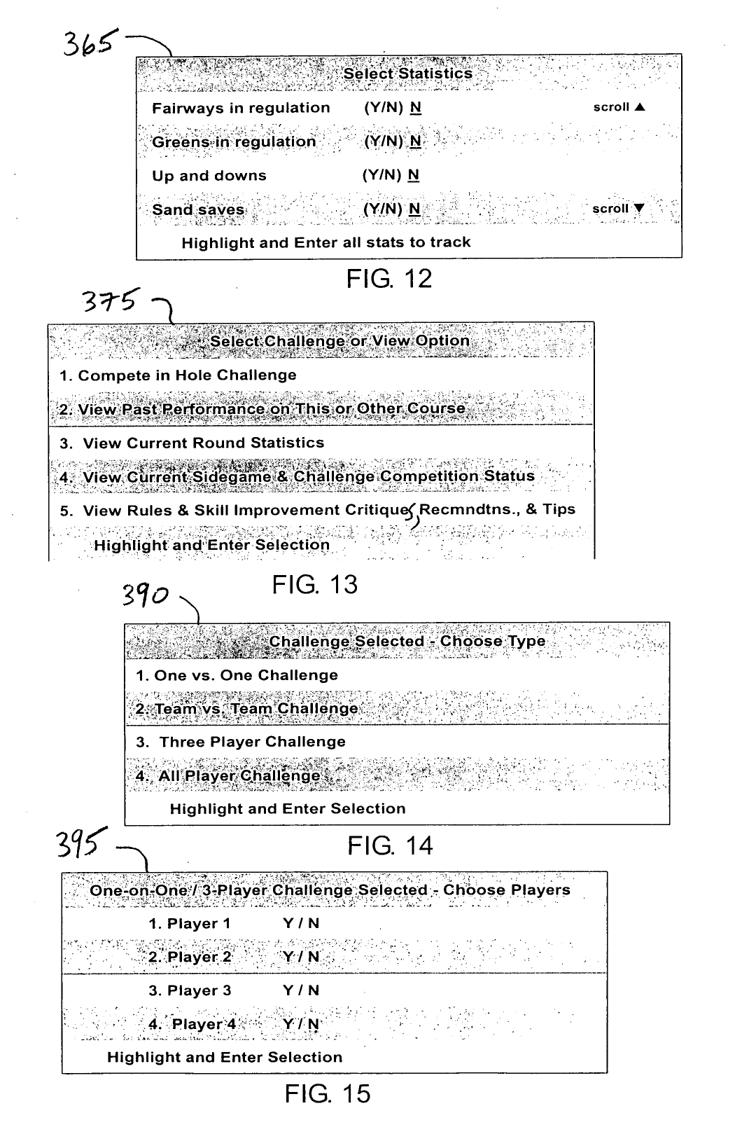

Next, the preferred device and system 100 can also be configured as schematically represented at step 350 (screen 355 of FIG. 11) to track hole-by-hole and overall round performance statistics including those selectable at step 360 and screen 365 of FIG. 12. Other statistics can be programmed into the device and system 100 by the golfer or user either during or before the round to be played, and can be identified and configured to have certain parameters identified for tallying during round play. Generally, as use of the device and system 100 proceeds, and while many other parameters of the device 100 may be configured before play, the round of play begins at this stage as depicted by the “START ROUND” step shown in FIG. 2B.

Although round play can commence and score and side game competition tallies may now be recorded, what has also be found to be highly desirable to enthusiasts, amateurs, and more advanced golfers, is the capability to establish and track various additional hole-by-hole challenges that often fall outside the scope of many more traditional competitive side games such as those mentioned elsewhere herein. More specifically, those having skill and knowledge in the relevant arts related to the field of invention, and of the sport of golf, have often attempted to challenge one another during rounds of play with various hole by hole challenges that are often accounted for with points assigned to a player having achieved various distinctions such as the most accurate (closest to hole) green shot, longest drive from the tee, best hazard recovery or obstacle avoidance shot (such as chipping onto the green from a bunker or slicing onto the green from around a tree or through a grove of trees, etc.). The variations of such challenges are as great in number as there are golf enthusiasts in the world. In the field of electronic score and competition tallying devices, it has thus become apparent that there is a need to interrupt the usual steps and processes involved in sequentially tallying strokes and side game points so as to further enable tallying of challenge competition points, which adds even further possible enjoyment to the round.

Accordingly, the instant invention is also directed various improvements in the art that enable more accurate and less cumbersome means by which such additional challenges can be tracked and tallied during a round of play without interference with the customary stroke and side game point tallies. In one possibly preferred or optional embodiment, the challenge point assignment and tallying capabilities are established as depicted in FIGS. 2B & 2C at step 370 and by corresponding exemplary display screen 375 of FIG. 13. Since many such challenges arise from rivalries established in previous rounds between participants, this step 370 can also incorporate any other desirable function and capability such as viewing of current and past performance data, rules for play, data on particular hole idiosyncrasies, among other possibilities. In one possible alternative to the preceding embodiments, with reference to screen 375 of FIG. 2C, it can be seen that it may be preferred to enable scoring and tracking of various such challenges as well as to enable viewing of, among other possible variations, (1) past performance on the current course by any player whose record is stored in the golf score and information device and system 100, (2) current round statistics, (3) current round side game and challenge competition points status and totals and tallies, and round and or tournament totals. Although most of the discussion of the various capabilities, features, and elements of the instant device and system 100 are explicated in the context of a single round of play, all such capabilities, features, and elements are contemplated for use in embodiments of the instant invention directed also to tournament play wherein multiple rounds are played, scored, and wherefore side game or competition and challenge points are sub-totaled by round throughout the duration of such tourney rounds.

In the event the a challenge is presented in a round of play at any particular hole, the user touch the screen or may depress any one or any combination of the possibly dedicated function key or keys 140, 142, 144, as well as any other predetermined key(s) of the data entry keyboard elements 150, to interrupt the round score process and to access the challenge and viewing capabilities. In any of such steps described herein, the user may also, in sequence or at any time during play and or during use of the device and system 100, select from any number of possible skill improvement tips and rules of play, such as skill improvement recommendations, critiques, and tips 380, 382, 384, 386, 388 (FIG. 2C), either during or outside of the challenge capability or any other main menu, scoring, and or viewing operations during use.

As those knowledgeable in the game and skills of golf may be able to comprehend, such possible skill improvement recommendations, critiques, and tips 380, 382, 384, 386, 388 (see, for example, FIG. 2C) are many in number and are generally and specifically contemplated for use in the context of the principles of the instant invention in all of the various preferred and optional modifications and alternatives of the various embodiments described herein. More particularly, in one possible variation, the contemplated skill improvement function of the instant device and system 100 can incorporate an indexed knowledge base or database of text-based, image-based, audio-based, and video-based information that can be downloaded into the device and system 100 by the manufacturer and thereafter by an individual user or an organization that may supply the device and system 100 to players. Further, as can be observed with reference to the text of item 380 of FIG. 2C, such recommendations and tips may be categorized in many useful ways that can include beginner, intermediate, and advanced groups of information, which can improve the ability to access relevant skill improvement information on demand. The contemplated knowledge base or database of such information can include indexed keywords and information classifiers that enable quick categorization and retrieval of relevant skill improvement information upon demand by the player or in an automated context-sensitive manner based upon default and or player-selected preferred or optional parameters and preferences. Further, such critique, recommendation, and tip skill improvement information can be adapted for such context-sensitive retrieval in view of the particular golf shot to be or that was played, or in the context of the skill level or handicap of a particular player, or in the context of the statistical performance of a particular player as such is analyzed relative to that player's mental game, long game, short game, and other player-specific performance statistics and assessments.

Of the many possible configurations of the skill improvement critique, recommendation, and tip capability of the device and system 100, various parameters and functions and capabilities can be optionally and preferably implemented that can improve the ease with which the user may retrieve, receive, download, reference, and view the skill improvement information described and contemplated here. With reference also now the text of item 382 of FIG. 2C, it can be further understood that such information can be selected to be retrieved, viewed, referenced, and displayed in the form of short, quick-reference keywords, in a brief or summary format, or in a more detailed descriptive prose format. In any of these formats, the user is can instantly change from one format to another and can also quickly display any relevant or desirable graphics, images, moving images, audio information, and or video information that may, in the context of the information contained in the specific or particular critique, recommendation, or tip being viewed or displayed, be part of and or relevant to that particular skill improvement information.

Further, the device and system 100 can be adapted to enable retrieval, viewing, and display of such skill improvement critiques, recommendations, or tips before, during, or after play of the current round of golf being played or scored, and or another round of golf stored in the device and system 100. Additionally, the device and system 100 is further selectably configurable and adaptable whereby such skill improvement critiques, recommendations, or tips are retrieved for display as a function of user selectable parameters and preferences that can be selected whereby the device and system 100 is configured to manually or automatically retrieve, reference, and or display such information either before or after a round is played, hole by hole, player by player, only for certain players in the round, or in various combinations thereof. In other words, for a particular round of golf, such skill improvement information can be displayed before or after a round for a certain player and or hole by hole for a different player. In yet more variations, the skill improvement critiques, recommendations, and tips can be retrieved and displayed in a general operational mode whereby such information that is relevant to tee-shots, obstacle navigation, chip shots, and long and short putting is generally displayed at the beginning of each hole or at the relevant points of play during the hole as a reminder, which mode can be particularly well-suited to beginners.

In yet other variations to any of the embodiments described here, a player performance and or context specific mode is implemented and selectable whereby an intermediate, or advanced or scratch player can be reminded and or can view on demand context-specific skill improvement critiques, recommendations, and tips that apply to or that are needed or perceived to be needed in view of the assessed performance and or statistically-based areas of improvement of that player. In any of such variations, such skill improvement information can be selectably referenced during play, or before or after play. The before or after reference capability is well-suited to players that do not respond well to or that they do not prefer to receive such information during play of a round of golf.

Referencing and attempting to absorb and implement skill improvement critiques, recommendations, and tips, during play of a round of golf can result in what is often referred to by those skilled in the game of golf, as well as those skilled in other sports, as analysis-paralysis, which in more detail and in the context of the game of golf means that the player can allocate too much mental energy to thinking about “how” to play a particular short and too little mental energy to actually implementing what the player knows or may be coming to know to be the optimum mental visualization, physical stance, swing, and follow-through needed for performing well on the shot of interest.

Many other possibly desirably capabilities and functions are also incorporated that can be set as a device and system 100 and or player-specific parameter or preference and can include critiques, recommendations, and tips such as those also illustrated in FIG. 2C in items 384 and 386, which can further incorporate text, graphics, audio, image, and video-based information as already described in connection with and otherwise contemplated by the embodiments of the instant invention.

Some such skill improvement critiques, recommendations, and tips can be cataloged and indexed as shown generally in Table 1 hereinbelow and can include, for purposes of further illustration, but not limitation, unique skill improvement information record identifiers such as “1.1” as well as various keywords and indexed and cross-reference terms that can enable rapid retrieval, reference, display, and viewing using the knowledge base and database features and capabilities disclosed herein as well as those available from Forescore™ Golf™, LLC, Columbus, Ohio, www.forescore.com. Although the indexed items on the following exemplary and greatly abbreviated knowledge base and database includes only skill level, shot type, description, keywords, and the like, many other possibly desirable or preferable index items are similarly compatible for use and contemplated for incorporation into the various embodiments of the instant invention. Some such additional index items can also include, for purposes of further illustration and example, but not for purposes of limitation, course and hole identifiers that can educate players to the intricacies and idiosyncrasies of a particular course and hole.

TABLE 1

| Skill Level | Shot Type | Critique, Recommendation, Tip |
|---|---|---|
| Beginner | Putting | 1.1 |
| | | KEYWORDS: Variably lengthen putting stroke |
| | | BRIEF: Variably lengthen putting stroke to develop judgment skill. |
| | | DETAILED: Lengthen your putting stroke incrementally to |
| | | increase the distance your ball rolls on the green. Develop your |
| | | distance judgment skills and translate that to the length of your |
| | | putting stroke. |
| Intermediate | Putting | 1.2 |
| | | KEYWORDS: Practice putting stroke using chalk line to hole |
| | | BRIEF: Putting stroke judgment is improved with 1 to 10 foot |
| | | practice putts along a snapped chalk line. |
| | | DETAILED: Create a 10 foot straight line by snapping a chalk line |
| | | on the practice green beginning from the mouth of the hole. Align a |
| | | golf ball on this line and stroke the ball with your putting stroke. |
| | | During the stroke keep the putter along the line to help create square |
| | | contact with the ball. Use this drill for short putts 6 feet and under |
| Beginner | Putting | 1.3 |
| | | KEYWORDS: Visualize best putt and stroke |
| | | BRIEF: Close eyes and visualize mental image of putt, then do it. |
| | | DETAILED: A common flaw people have with putting is that their |
| | | mind often jumps from the ball to the hole. Once you have selected |
| | | the line of the putt, visualize the ball rolling on that line and into |
| | | the cup. You can even close your eyes and picture the putt before |
| | | making the stroke. Then open your eyes and execute what you just |
| | | visualized. |
| Beginner | Putting | 1.4 |
| | | KEYWORDS: Optimize posture and foot placement before putt |
| | | BRIEF: Use good posture and foot placement to optimize putt |
| | | DETAILED: A mechanically correct putting stroke stems from |
| | | good posture and ball position. 1. When setting your ball position, |
| | | notice where your ball is with relation to your feet. 2. Experiment |
| | | with the position of your feet and take note of what happens when |
| | | you are too close or too far from the ball. 3. The correct posture and |
| | | ball position will allow you to bring your putter straight back and |
| | | straight through naturally. |
| Beginner | Putting | 1.5 |
| | | KEYWORDS: Practice putt strokes before actual putt |
| | | BRIEF: Acquire feel and rhythm with practice putt strokes before |
| | | actual putt. |
| | | DETAILED: Make sure to take a few practice strokes next to the |
| | | golf ball before hitting the putt. This action will help you gain the |
| | | proper feel and rhythm needed to put a pure stroke on the ball. Try |
| | | lining up the brand label on the golf ball with the hole. This |
| | | provides a good visual reference that will aid in proper alignment. |
| | | When setting up for the putt, make sure that your eyes are directly |
| | | over or just inside the golf ball. This will assist in squaring the |
| | | putter face with the golf ball for proper aim. |
| Advanced | Putting | 1.6 |
| | | KEYWORDS: For fast green, lower grip of putter shaft |
| | | BRIEF: Grip down on putter shaft to lessen putt speed on fast greens. |
| | | DETAILED: For fast greens grip down on the putter shaft, |
| | | effectively shortening the club's length. Just as choking down on a |
| | | full-swing club produces a shorter shot, grasping the putter at the |
| | | bottom of the grip, even down on the metal, will produce slower |
| | | rolling, shorter putts. And you still get to make contact on the sweet |
| | | spot, so the ball starts and stays on-line and has a better chance of |
| | | going in the hole. |
| Intermediate | Putting | 1.7 |
| | | KEYWORDS: Slightly adjust putt setup and stroke and lock on |
| | | BRIEF: Recall good putting days and adjust setup, stance, tempo, |
| | | and stroke to that day for more consistent putts |
| | | DETAILED: To me, putting is inspirational, not mechanical. My |
| | | hot streaks usually start with making slight adjustments to my setup |
| | | or stroke, like standing a little more open or slowing my tempo, |
| | | until something clicks. When it does, I lock onto it and ride it out. |
| | | Try to identify what feels different on your good days, then recall it |
| | | when your putting turns sour. |
| Intermediate | Putting | 1.9 |
| | | KEYWORDS: Be aggressive on uphill and gentle on downhill putts |
| | | BRIEF: Putt straight in on uphill, ball is stopped by backstop of rear |
| | | cup wall, BUT curl into downhill with gentle stroke since backside |
| | | of cup wall is lower than front cup wall. |
| | | DETAILED: Short Putts: My general rule is to hit uphill breaking |
| | | putts aggressively but downhill breakers gently. Going uphill, the |
| | | back of the hole is higher than the front, which creates a backstop |
| | | for firm, straight-in putts. The opposite is true going downhill, |
| | | where the back edge is lower, making the hole less forgiving. That's |
| | | why I prefer to curl in down hillers |
| Beginner | Putting | 1.9 |
| | | KEYWORDS: Strive for 3 foot tap-in circle on long putts |
| | | BRIEF: When under pressure, just seek to put ball into the 3-foot |
| | | circle surrounding the cup to ensure final stroke only needs a tap in. |
| | | DETAILED: 3 Putts: We all love making long putts, but my |
| | | objective from about 12 feet and out -- particularly under pressure -- |
| | | is to leave myself a tap-in when the ball doesn't drop, which is most |
| | | of the time. To help me gauge speed, I focus on rolling the ball at a |
| | | speed that will put it within a three-foot circle around the hole. |
| Beginner | Obstacle, | 2.1 |
| | General, | KEYWORDS: Contact 2 inches behind ball, plant feet, open stance |
| | Bunker | and club, grip down, normal swing |
| | | BRIEF: Plan to contact 2 inches behind ball, securely plant feet, |
| | | grip down on shaft to compensate for depth of feet in sand, open |
| | | stance and club and use normal swing. |
| | | DETAILED: Here's a piece of advice for poor bunker players. The |
| | | next time you are in the sand use your normal swing with the set-up |
| | | described below. Pick a spot a couple of inches behind the ball and |
| | | try to make contact there. Concentrate on that spot as hard as you |
| | | normally would the ball. Now that you know where to make |
| | | contact, set up with the ball positioned opposite your left heel, open |
| | | your stance, open the clubface, shuffle your feet into the sand until |
| | | you feel securely planted, and grip down a little to adjust for the |
| | | lowered level of your feet. Go ahead and make your normal golf |
| | | swing as smoothly as you know how. I think the results will please you. |
| Intermediate | Obstacle, | 2.2 |
| | Fairway, | KEYWORDS: Stand tall close to ball with feet planted, choke |
| | Bunker | down grip, hit thin, stay level for ball first contact |
| | | BRIEF: Get closer to ball to stand taller and hit ball first with a thin |
| | | shot to minimize sand, choke down to compensate for depth of feet |
| | | in sand, swing level and hit ball in middle of stance. |
| | | DETAILED: In fairway bunkers, being closer to the ball allows you |
| | | to stand taller. Standing tall helps you clip the ball without taking |
| | | much sand. It helps hit it a bit thin, something great fairway bunker |
| | | players like Jack Nicklaus and Mark O'Meara seem to do every |
| | | time. They stay very level throughout the shot. Also try and play the |
| | | ball toward the middle of your stance, which promotes ball first |
| | | contact. Use anywhere from half to a full club more than normal for |
| | | the shot, dig your feet in the sand and choke down a similar amount. |
| | | The ball flight tends to be a little lower because you're trying to |
| | | hit it thin. If you take a lot of sand, you won't hit the ball solid. |
| Intermediate | Obstacle, | 2.3 |
| | General, | KEYWORDS: Use left toe and center stance guide lines spaced at 6 |
| | Bunker | inches, splash sand onto green to optimize depth of swing into sand |
| | | BRIEF: Without a ball, with 2 lines spaced 6 inches apart and |
| | | perpendicular to target line, practice swing to optimize impact depth |
| | | between lines to extract right amount of sand onto green. |
| | | DETAILED: Draw two lines in the sand about six inches apart. |
| | | Take your stance with the back line aligned with the center of your |
| | | stance and the front line aligned with your front toe. At first |
| | | perform this drill without a ball. The object is to splash the sand that |
| | | lies in between the two lines out of the bunker and onto the green. |
| | | This drill encourages the club to accelerate through the sand. When done |
| | | with the golf ball, the golfer learns the swing the sand wedge the |
| | | proper depth to extract the right amount of sand. |
| Beginner | Obstacle, | 2.4 |
| | General, | KEYWORDS: Follow through on swing, hit behind ball and let sand |
| | Bunker | deaden impact. |
| | | BRIEF: Impact sand behind ball to soften impact, and follow |
| | | through on swing to finish, only shorten finish on buried ball or |
| | | when only a little green is available. |
| | | DETAILED: The biggest mistake amateurs make is failing to finish |
| | | their swing. They hit into the sand properly, but then they just stop, |
| | | and the ball stays short. The key to getting out of the bunker, onto |
| | | the green and to the hole is to make a full follow-through. Don't worry |
| | | about hitting the ball too far. If you've hit far enough behind it, |
| | | the sand will cushion the shot. The only time you should shorten |
| | | your finish is if the ball is buried or you have little green to work with. |
| Advanced | Obstacle, | 2.5 |
| | General, | KEYWORDS: Swing through sans trail hand and splash sand without |
| | Bunker | ball and then with ball |
| | | BRIEF: Top out back swing with normal grip, release trail hand, swing |
| | | through without ball to splash sand, introduce ball when comfortable. |
| | | DETAILED: Set up in the bunker. Now swing to the top of your |
| | | backswing. Now release the grip of your trail (bottom) hand. Swing |
| | | through to a full finish. It is best to learn this drill without the |
| | | golf ball at first to gain the proper feel of the drill. Once you can |
| | | comfortably splash sand onto the green introduce a golf ball into the |
| | | drill. This drill is difficult but the benefits are great. |
| Intermediate | Chipping, | 3.1 |
| | Chip Shot, | KEYWORDS: Normal course - use regular chip, fast course or little |
| | Wedge Shot | green - use backspin chip, slow course or much green - use runner chip |
| | | BRIEF: Normal shot or course, regular chip shot, dry or fast course - |
| | | add some backspin on chip to slow down ball, wet or slow course - |
| | | speed up ball with some hook-spin on chip shot. |
| | | DETAILED: Once I decide to play a chip shot, I have three types of |
| | | chips from which to choose: the basic chip, the backspin chip, and |
| | | the runner. Picking the right one for the situation at hand |
| | | dramatically increases my chances for success. When ground and |
| | | course conditions are normal, I play the basic chip, guiding the club |
| | | back and through with my left hand and letting my right hands |
| | | establish the hit, with no rolling of the wrists. When I need a softer |
| | | shot with some bite, I choose the backspin chip, opening the |
| | | clubface slightly at address and trying to cut across the ball from out |
| | | to in to impart backspin. And when I have a lot of green to work |
| | | with, I use the runner, in which I swing from in to out through |
| | | impact, rolling my wrists over and applying hook-spin to the ball. |
| | | Try these shots for yourself, and develop a feel for when and how to |
| | | use them on the course. Remember, learning to pick the right chip is |
| | | just as important as mastering the technique. |
| Advanced | Chipping, | 3.2 |
| | Chip Shot, | KEYWORDS: Putt stroke with fairway wood to chip onto green |
| | Wood, | unless in tall grass |
| | Driver | BRIEF: Minimize chip shot risk by using fairway wood with a |
| | | putter grip, keep body, head, and knees still, do not break wrists. |
| | | DETAILED: Using the fairway wood around the green can take |
| | | away a lot of risk in a chip shot. The fairway wood can be used |
| | | whether your lie is a short distance from the green or all the way |
| | | across the green -- unless your ball is in the deep grass. When |
| | | hitting the fairway wood, you need to: 1. Use your putting grip and |
| | | keep your body still. 2. Do not move your knees or your head. |
| | | 3. Take a regular putting stroke with no break in your wrist. |
| | | Mastering this shot can greatly improve your short game. |
| Beginner | Chipping, | 3.3 |
| | Chip Shot, | KEYWORDS: Chip and Run for Accuracy |
| | Wedge | BRIEF: Chip and run when reliability needed. |
| | | DETAILED: The chip and run should be the workhorse of your |
| | | short game. It is the most reliable shot around the green. Getting the |
| | | ball on the ground and rolling as soon as possible greatly increases |
| | | the chances of the ball's behavior being predictable. That is not to |
| | | say that a chip and run is always very low to the ground . . . just |
| | | as low as possible. A chip and run style shot can be played with the most |
| | | lofted wedge in your bag, in which case some people might refer to |
| | | the shot as a “pitch and run.” In many cases where the average |
| | | golfer tries to pitch the ball up in the air, the “risk vs. reward” |
| | | and the uncontrollable nature of a pitch make it a poor choice. |
| Intermediate | Pitching, | 4.1 |
| | Wedge | KEYWORDS: Rear stance ball lowers trajectory with more roll, |
| | | center stance ball gives medium trajectory and roll, forward stance |
| | | ball gives higher trajectory and little roll. |
| | | BRIEF: Back stance ball position lowers spin and trajectory and |
| | | gives more roll out, center stance position gives medium spin and |
| | | trajectory, forward stance ball position minimizes roll with higher |
| | | trajectory. |
| | | DETAILED: Use this drill see the difference in trajectory and spin |
| | | produced by using different ball positions in your pitch shots. |
| | | A regular pitch shot uses a centered ball position and creates a |
| | | medium trajectory with medium spin. A ball position in the back of the |
| | | golfer's stance produces a pitch shot with a lower trajectory and |
| | | slightly less spin causing the ball to roll more after the first bounce. |
| | | A forward ball position creates a high trajectory and the ball lands |
| | | softer on the green and stops sooner. Practice using all three ball |
| | | positions and observe the differences. Once familiar with the differences |
| | | you can apply these shots to your game giving you more options. |
| Intermediate | Pitching, | 4.2 |
| | Wedge | KEYWORDS: Hinge, unhinge, and hold |
| | | BRIEF: Pitch higher by hinging wrists, unhinging, and then holding |
| | | wrists with strike applied on impact. |
| | | DETAILED: Many weekend players try to pitch with stiff wrists. |
| | | To pitch at a high level, you must hinge your wrists and apply the |
| | | strike at impact. More simply, hinge, unhinge, and hold. |
| Intermediate | Pitching, | 4.3 |
| | Wedge | KEYWORDS: With constant tempo, practice distances with swings |
| | | from 9, 10, and 11 hour visualized clock positions. |
| | | BRIEF: Using a constant tempo swing, practice 12 wedge shots |
| | | with swing from 9, 10, and 11 hour visualized positions of |
| | | imaginary clock for each wedge to create several shot distances. |
| | | DETAILED: To lower your scores, distance control with wedges is |
| | | critical. Hit a dozen wedge shots, swinging your lead arm until it is |
| | | level with the ground on the backswing -- 9 o'clock. Make sure you |
| | | keep the same tempo on each swing, and check the distance your |
| | | ball flies. Then swing to 10 o'clock and 11 o'clock and do the |
| | | same. You should have three different distances. Try this with your other |
| | | wedges and you'll have a total of six or nine distances. To hit a |
| | | 70-yard shot, just tell the time of your swing. |
| Advanced | Rough, | 5.1 |
| | Long Shot, | KEYWORDS: Place ball in back of stance for low flying runner, |
| | Fairway, | punch hard with square or slightly close club face |
| | Green | BRIEF: Maximized distance from rough is obtained with ball |
| | | placed in rear of stance; swing hard with square or slightly closed |
| | | club face and with hands ahead of ball. |
| | | DETAILED: For maximum distance from rough, especially when |
| | | pinpoint accuracy isn't critical, try a second technique. Set up for |
| | | a low-flying runner by positioning the ball back, your hands forward, |
| | | and the clubface square to slightly closed. Then punch down hard |
| | | while keeping your hands ahead of the ball through impact. This |
| | | technique won't produce miracles, but, employed wisely, will help |
| | | contain your mistakes when you wander off the fairway. |
| Intermediate | Rough, | 5.2 |
| | Long Shot, | KEYWORDS: Get high trajectory and quick stop with ball placed |
| | Accurate, | forward, swing with slightly open club face, grip with left, and |
| | High, | move club hard with right. |
| | Stop Roll | BRIEF: Get ball to fly high and stop short with ball placed forward |
| | | in stance and slightly open club face, grip well with left hand and |
| | | vigorously throw club with right hand though impact. |
| | | DETAILED: For a shot that will fly high and stop relatively |
| | | quickly, set the ball well forward in your stance, open the clubface |
| | | slightly, and then hang on with your left hand while throwing the |
| | | club forcefully with your right hand through impact. This technique |
| | | won't produce miracles, but, employed wisely, will help contain |
| | | your mistakes when you wander off the fairway. |
| Intermediate | Knock down, | 6.1 |
| | Wind, | KEYWORDS: Fly lower and shorter with more roll in wind, up |
| | Weather | club or two, stand close, grip down, swing with ¾ motion slightly |
| | | behind ball. |
| | | BRIEF: With wind, fly lower, shorter with more roll, up club or |
| | | two, stand closer to ball and grip about 3 inches down from normal, |
| | | swing for impact slightly behind ball and swing with ¾ motion. |
| | | DETAILED: Hitting the ball low into the wind is not a new idea, |
| | | but I use my knockdown shot in any kind of wind. It's a very |
| | | predictable, controllable play. First, I take an extra club or two |
| | | because the shot carries less. Then, I grip down about three inches |
| | | and stand a little closer to the ball, which I play slightly behind my |
| | | normal ball position for whatever club I'm using. From that set-up, |
| | | it's just a matter of making a three-quarter motion back and through, |
| | | and keeping it smooth. The ball will fly lower, shorter, and with |
| | | more roll. |
| Beginner | Knock down, | 6.2 |
| | Wind, | KEYWORDS: Overestimate the wind, visualize cup moved for |
| | Weather | break and wind. |
| | | BRIEF: Effective cup position moved for break and wind effect, |
| | | visualize aiming point on imaginary green before and during putt. |
| | | DETAILED: On a breaking putt, the center of the cup in effect |
| | | moves left or right. Just as you need to visualize that, you need to |
| | | visualize the influence of a crosswind by picturing an imaginary |
| | | green. Let's say the wind is blowing from left to right at about 15 |
| | | miles per hour. My aiming point might be the left edge of the real |
| | | green. But if the wind's blowing 30 miles per hour, I might aim at |
| | | the left edge of the imaginary half green. If anything, you should |
| | | overestimate the wind. |
| Intermediate | Impact, | 7.1 |
| | General, | KEYWORDS: Square shoulders to target line on impact |
| | Drive, | BRIEF: At impact, be certain shoulders are square to target line, |
| | Iron, | hips are open toward & more weight is on foot closest to target. |
| | Fairway, | DETAILED: When making impact with a golf ball, great players |
| | Tee Shot, | have three things in common 1. Their hips are turned open toward |
| | Stance | the target 2. Their weight is on the side closest to the target 3. Their |
| | | shoulders are square to the target line. |
| Advanced | Impact, | 7.2 |
| | General, | KEYWORDS: Get swing bottom to front of ball |
| | Drive, | BRIEF: Practice hitting ball before ground by getting bottom of |
| | Iron, | swing in front of ball by getting divots consistently forward of ball |
| | Fairway, | DETAILED: A very important factor in striking the ball solidly and |
| | Tee Shot, | consistently with your irons is getting the “bottom” of your swing |
| | Stance | in front of the ball. This promotes contacting the ball before the |
| | | ground (this is a good idea). You can develop a feel for this by |
| | | scratching a line on the ground with a tee, or making a row of |
| | | tees spaced about 6 inches apart, perpendicular to your target line. |
| | | Straddle the line and take divots until you consistently make the |
| | | divots in front of the line (toward the target), or in front of the row |
| | | of tees. Once you can do this you'll hit your iron shots much more |
| | | solidly and with more control. |
| Beginner | Impact, | 7.3 |
| | General, | KEYWORDS: Address ball, close eyes, visualize jump up, feel balance |
| | Drive, | BRIEF: Maintain centered balance, address ball, close eyes, |
| | Iron, | visualize a quick jump up to get balanced posture and stance across |
| | Fairway, | feet before swing. |
| | Tee Shot, | DETAILED: Few things are more important to consistent shot |
| | Stance, | success than good balance. To center your balance, try this: Get in |
| | Balance, | your address position, close your eyes, and imagine you're about to |
| | Swing, | spring straight up. Doing so would require your balance to be |
| | Visualize | centered -- not favoring your right or left foot or your toes or heels. |
| | | Use this “center balanced” feeling as the base for your golf |
| | | swing, and your ball striking will become more consistent and |
| | | predictable. You might also pick up a bit of distance because your |
| | | swing will be more athletic. |
| Intermediate | Impact, | 7.4 |
| | General, | KEYWORDS: On impact, left arm & wrist and shaft must align |
| | Drive, | BRIEF: Keep left wrist flat or straight as you impact so the club |
| | Iron, | shaft and the left arm and wrist are aligned to maximize impact. |
| | Fairway, | DETAILED: At impact your left arm, left wrist, and club shaft |
| | Tee Shot, | should all line up with each other. The only way to accomplish this |
| | Stance, | is to have a flat left wrist. I have a drill that will help you develop |
| | Balance, | this skill: Hit chip shots, taking the club back only a couple of feet |
| | Swing, | on the backswing and follow-through. Hold the follow-through |
| | Chip Shot | position and check your left wrist. If it's flat, you will be hitting |
| | | solid golf shots. |
| Beginner | Impact, | 7.5 |
| | General, | KEYWORDS: Do not open club face on backswing to max impact |
| | Drive, | BRIEF: Address the ball, square the clubface, and do not open |
| | Iron, | during backswing to maximize impact. |
| | Fairway, | DETAILED: If you don't open the clubface during the backswing |
| | Tee Shot, | then you don't have to close it on the downswing. It's that simple. |
| | Stance, | If the clubface stays square or even slightly closed to your shoulders |
| | Swing | during your backswing, then all you have to do is turn your |
| | | shoulders on the downswing and the club will return to the ball in |
| | | nearly the same position you had at address -- square to the target. |
| | | That ideal impact position will give you some of the most solid |
| | | shots you've ever hit. |
| Beginner | Impact, | 7.6 |
| | General, | KEYWORDS: Grip just enough to prevent slip |
| | Drive, | BRIEF: Relax hands on grip until club grip is just about to slip |
| | Iron, | DETAILED: Too much grip pressure can prevent a golfer from |
| | Fairway, | swinging the club properly. To feel how easy you can hold onto a |
| | Tee Shot, | club and still be able to control it, hold the club in front of you so |
| | Swing, | the shaft is vertical. Take your normal grip but relax your hands as |
| | Grip | much as you can before the club starts to slip through your fingers |
| | | and fall to the ground. Your grip pressure should be slightly firmer |
| | | than the pressure the moment before the club slips. |
| Intermediate | Impact, | 7.7 |
| | General, | KEYWORDS: Hit with feet together to maintain inside swing path |
| | Drive, | BRIEF: Practice hitting with feet together to correct overturn on |
| | Iron, | swing to lessen pull or slice. |
| | Fairway, | DETAILED: Many golfers overturn their bodies in the backswing, |
| | Tee Shot, | which causes them to overturn in the downswing. This causes a |
| | Balance, | swing shape too inside on the backswing and too outside coming |
| | Stance, | down resulting in a pull or a slice. To fix this problem, practice |
| | Swing | hitting balls with your feet together. This lets the arms swing back |
| | | and through on an inside path, and forces you to stay in balance |
| Intermediate | Impact, | 7.8 |
| | General, | KEYWORDS: Address properly, rotate +/− 90 degrees, check shaft |
| | Drive, | direction |
| | Iron, | BRIEF: Check posture by addressing, rotating +/− 90 degrees, |
| | Fairway, | and checking for correct club shaft direction at extents of rotation. |
| | Tee Shot, | DETAILED: Good posture can have a huge impact on ball striking. |
| | Balance, | For proper posture, get into your address position. Now place the |
| | Stance, | club across your shoulders and onto each end, maintain your address |
| | Swing | position's posture. Turn your shoulders like you would taking the |
| | | club away. Once your shoulders have turned 90° or as far as they |
| | | will turn, take notice where on the ground the end of the shaft is |
| | | pointing. Now rotate your body through to the so your shoulders |
| | | have turned 90° past your address position. Where does the other |
| | | end of the shaft point? Ideally the end of the shaft at this point |
| | | of the drill should point at the same spot at the first checkpoint. If you |
| | | have done this correctly then your posture is great. If the ends of the |
| | | shaft weren't pointing at the same spot then practice this drill |
| Advanced | Impact, | 7.9 |
| | General, | KEYWORDS: Right leg flex minimizes blading and topping |
| | Drive, | BRIEF: Flex right leg, do not straighten, body down on back swing |
| | Iron, | to prevent blading and topping the ball. |
| | Fairway, | DETAILED: If you have problems blading shots or topping the |
| | Tee Shot, | ball, you have to maintain the flex in your right leg during the |
| | Balance, | downswing. If this leg straightens, your body will rise up, and the |
| | Stance, | likely outcome is that the leading edge of the club will strike the |
| | Swing | ball at its equator or on the top of it. Remember, as the arms go up |
| | | during the backswing, the body must stay down. |
| Beginner | Wood Play, | 8.1 |
| | Drive, | KEYWORDS: Practice improved driver contact, hit tee only |
| | Distance, | BRIEF: Practice hitting tee without ball and without ground contact |
| | Tee Shot | DETAILED: Many people complain about not being able to hit the |
| | | ball well with their woods, and in particular their driver. From what |
| | | I've seen poor quality contact is a major problem for many players. |
| | | Put a tee in the ground (without a ball) sticking up approximately 1 |
| | | inch. You should be able to strike the tee consistently without |
| | | hitting, or even brushing, the ground at all. If you miss the tee, or |
| | | touch the ground in any way, don't wonder any longer why you |
| | | can't hit your driver. Remember--the longer the club, the more precision |
| | | required. Practice this exercise until you can consistently clip the tee |
| | | without touching the ground (or even the grass). Once you get |
| | | quality contact handled the feedback you get from your shots |
| | | becomes meaningful. Then you can work on directional control. |
| Beginner | Wood Play, | 8.2 |
| | Drive, | KEYWORDS: Proper address stance, no reaching. |
| | Distance, | BRIEF: Address & stand at proper distance from ball, no reaching |
| | Tee Shot, | DETAILED: One of the most common faults I see average players |
| | Swing, | make with the driver is to stand too far from the ball. Reaching for |
| | Stance | the ball like this gets your weight too far out over your toes and your |
| | | spine angle too tilted. During the swing, gravity pulls your weight |
| | | toward the ground, and you lose your balance. I pay close attention |
| | | to my setup and make sure I'm in a more athletic position, like a |
| | | basketball player on defense. My weight is on the balls of my feet, |
| | | not my toes. If somebody came up behind me when I was at address |
| | | and gave me a shove, I'd be able to keep my balance. |
| Intermediate | Drive, | 8.3 |
| | Iron, | KEYWORDS: Max shoulder turn to max distance |
| | Wood, | BRIEF: Left shoulder under chin turn, then swing for max distance |
| | Distance, | DETAILED: One way to increase your distance is by focusing on |
| | Tee Shot, | making as large of a shoulder turn as possible. Once in your |
| | Swing, | address, make it your goal to get your left shoulder beneath your |
| | Stance | chin. When initiating your downswing, you will feel a force being |
| | | generated from your right heel to your left shoulder. This force |
| | | creates extra club head speed and should result in increased |
| | | distance. Concentrate on extending your arms and accelerate |
| | | through the ball and past your body. |
| Intermediate | Drive, | 8.4 |
| | Iron, | KEYWORDS: Weightless ball, Stay Loose |
| | Wood, | BRIEF: No need to muscle a weightless popcorn ball off the tee |
| | Distance, | DETAILED: Many golfers swing smoothly in the practice swing, |
| | Tee Shot, | but add a ball to the equation and they invariably try to muscle it -- |
| | Swing, | as if they were hitting a bowling ball. Tightening the arms and |
| | Stance, | wrists in the downswing causes movement in the swing path and |
| | Mental, | off-center shots. Instead, visualize the ball as being weightless, like |
| | Visualize | a piece of popcorn. In fact, take some popcorn to the practice tee |
| | | and alternate hitting golf balls and pieces of popcorn. The result will |
| | | be a smoother swing and much straighter shots. |
| Beginner | Swing, | 9.1 |
| | Stance, | KEYWORDS: Loosen up, hover & rock club |
| | Mental, | BRIEF: Clear mind before swing, hover & rock club in front of ball |
| | Visualize | DETAILED: When you've got a million swing thoughts going |
| | | through your head the easiest way to remove the tension out of the |
| | | set-up position and to start the swing in rhythm is with this simple |
| | | pre swing drill: Start your swing by hovering the club a couple of |
| | | feet in front of and above the ball. It's a rocking motion to loosen |
| | | up and have some momentum for a much freer start to the swing. |
| | | Remember, most swing errors happen at the start. If you can get a |
| | | good start where you synchronize the swinging of the club with the |
| | | turning motion of the body, it gets you into the flow and helps you put |
| | | the club in good positions without having to think too much about it. |
| Advanced | Slice Cure, | 9.2 |
| | Swing, | KEYWORDS: Kill slice, close stance, right foot back |
| | Drive, | BRIEF: Cure slice with closed stance, pull back right foot |
| | Iron, | DETAILED: One of the most effective anti-slice drills involves |
| | Wood | swinging with the right foot pulled back from the target line in an |
| | | exaggerated closed stance. This does several things that help you |
| | | draw the ball: It allows you to make a bigger turn; It moves your |
| | | right hip out of the way to give you room to drop your arms into the |
| | | slot and bring your club on plane at impact; It promotes the proper |
| | | hand action, for a better release. |

As incorporated with any of the variations, modifications, and alternative configurations described herein and contemplated hereby, the manufacturer, association, club, and or user supplied and or updateable skill improvement critique, recommendation, and tip information and index items can also include hole and course features, intricacies, recommendations, tips, and suggestions, as well as a host of other possibly preferred and optional data. Such further knowledge base and data base cataloged and categorized information can also preferably and optionally include cataloged and categorized information about various types of golf equipment, components, and accessories that can further include clubs, balls, and rules and regulations therefore, and other devices.

It may be further understood that these knowledge base and database skill improvement critique, recommendation, and tips features, functions, and capabilities can be used either alone and or in combination with any of the other features, functions, capabilities of the novel device and system 100 according to the principles of the instant invention. More specifically, the skill improvement capabilities can be used with any of the data upload and download and synchronization capabilities contemplated and described elsewhere herein, which can particularly useful and of benefit whereby the one or more players can upload scoring information to a host system of a club, association, or a particular player's personal computer or portable data assistant. After such upload, various types of statistical performance analyses can be performed on the uploaded data to assess and identify particular player idiosyncrasies for all or any player of interest, which player assessments and idiosyncrasies can be correlated to various critiques, recommendations, suggestions, and tips that are identified and selected from a centralized and or more comprehensive knowledge base and or database than that which may be contained in the memory of the inventive device and system 100. Either optionally or preferably, additional such correlated and identified critiques, recommendations, suggestions, and tips can be selectably downloaded back into the memory of the device and system 100 for post play review by the player of interest, and or for review prior to the next round of golf, and or for review hole by hole, or shot by shot, or player by player, as may be preferred or desired by the one or more players. In this way, the one or more players may retrieve, reference, and review such critiques, recommendations, suggestions, and tips so as to obtain skill improvement reinforcement and to gain context-sensitive and useful insight and advice to improve their skill before, during, and after play of a round of golf.

Returning again to the contemplated challenge capabilities of the instant device and system 100, and with continued focus on step 370 and reference now also to screen 390 of FIG. 514, a user can quickly and easily setup a one-on-one challenge between any two players in a round, or can establish a challenge that can be accounted for on a team versus basis, or between three, four, or all players. Although only a three player option is depicted on screen 390, this capability can also be adapted for multiplayer challenges in excess of three or four players but less than all players in the round being tallied in the golf information and display device and system 100.

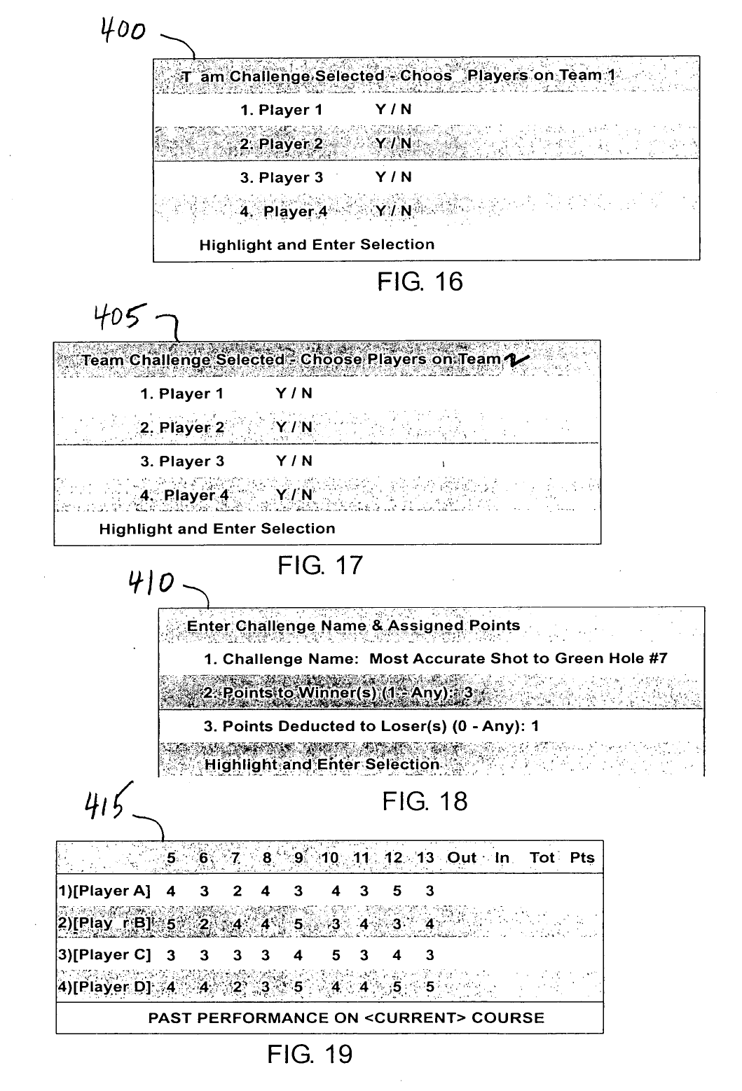

Selecting which players are to engage in the contemplated hole challenge can be organized as illustrated in screen 395 of FIG. 15 wherein the user setting-up the challenge in the device and system 100 can simply highlight and select players to participate. In a team versus team type challenge, players for each team can be readily selected in similar fashion and possibly or preferably as depicted on screens 400 and 405 of FIGS. 16 and 17, respectively. Once participating players of such a hole-by-hole challenge are quickly selected, then various challenge parameters are often established. Although many similarly effective variations are contemplated for purposes of the instant invention, one possible preferred or optional capability for identifying and entering such challenge parameters is depicted by screen 410 of FIG. 18. Some of such challenge characteristics that may be desirable can include, for purposes of further illustration without limitation, a text or numeric name for the particular challenge that can be anything including “Hole 12, Bob's Weed-Whacking Green Chip” or “Al's mud-chip to fairway on 7” or any other suitable identifier. Additionally, the name field can also be populated with any other numeric or text-type information relevant to the particular challenge. Among other possibly desirable parameters, the user can choose to point values that will be added to the competition point total of the winner or winners of a challenge, as well as point values, if any, that are to be deducted from the competition point totals of the losers of the challenge.

In such intra-round challenge play, it has also been found to be desirable to enable quick and easy text data entry so that users can focus on the round of play instead of entering text data into the name fields for any functions of the instant device and system 100. Accordingly, those having skill in the relevant arts can appreciate that the golf score and information display device and system 100 may also preferably or optional incorporate one or more quick-lookup databases of words from the language programmed into the device and system 100, which can be English or any other suitable language. The preferred or optional capability for quick-lookup of words would enable the user entering text data into the device and system 100 to simply enter one or more characters whereupon the device and system 100 is adapted to display either a pop-up window that displays all words having the sequence of characters matching those entered thus far by the user. The added capability also then enables the user to select the desired word, if it is available, which will be automatically entered at that point in the data entry process without the need for the user to enter or type the remaining characters.

With continued reference to the various preceding figures associated with step 370, it can also be seen that the golf score and information display device 100 can be configured whereby the user may interrupt round stroke and competition point tallying to view various data stored in the memory 110 of the device and system 100. With specific reference now also to screen 415 of FIG. 19, it may be understood that the device and system 100 can preferably or optionally be adapted to display past hole stroke performance and other related information for the current course under play whereby the phrase “<current>” of FIG. 19 can be replaced with the name of the actual course for the round. The device and system 100 can be further adapted to display such information for any or all players recorded in the memory 110 and to show summary performance information, or to show detailed, hole-by-hole past performance.

The instant inventive device and system 100 enables golfers to quickly access this type of specific past performance during a round because this capability has been found to often lead to even more entertaining play in that players can instantly recall past statistics and gain the confidence needed to assert additional challenges to other players on difficult holes, or to recall that past performance on a specific hole was less than desired such that a new challenge might be inadvisable. As with any of the preceding preferred embodiments, and the many variations, alternatives, and modifications thereto, in the circumstance where more players are stored than can be displayed on the particular display 120 of the assembly 130, then the preferred or optional capability to scroll through such displayed information either horizontally, to see hole-by-hole statistics, and vertically, to view player-by-player, round-by-round statistics, will be especially desirable.

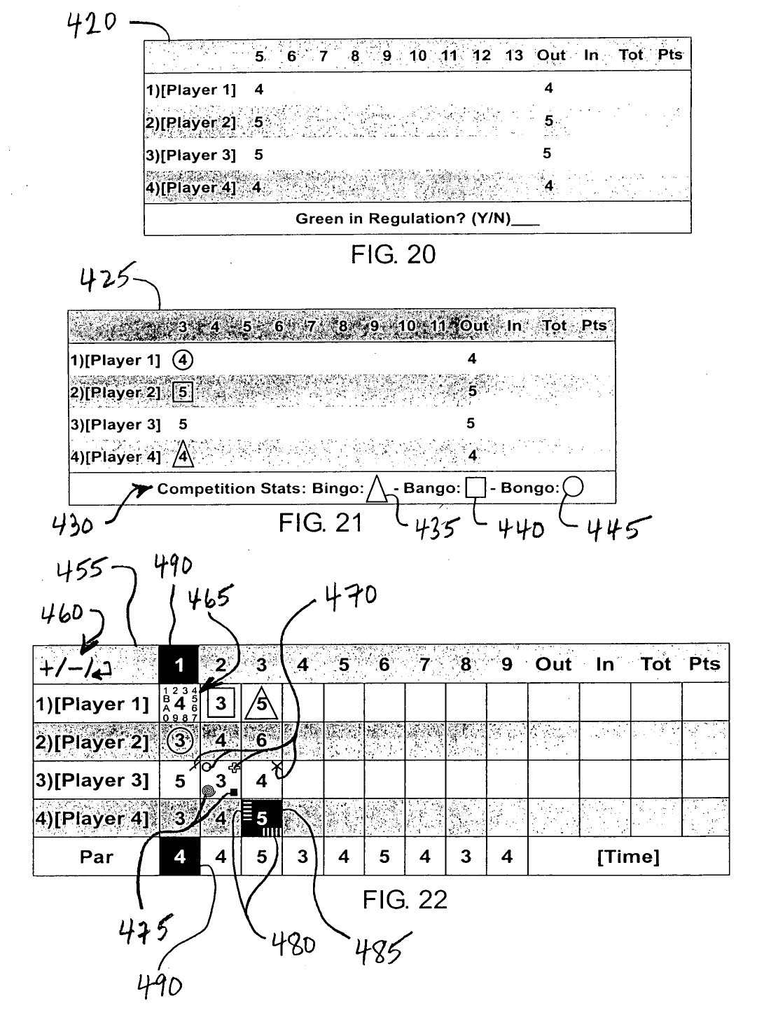

With continued reference to step 370 and screen 375 of FIG. 13, and with additional reference now also to screen 420 of FIG. 20, it can be seen that the device and system 100 can also enable viewing of various information including performance statistics, competition point totals, and other useful data for the current round of play. As further depicted in another illustrative example, screen 430 of FIG. 21 can be adapted to display detailed and or summary information for the various current side games in which the current players may be involved for the current round. In any of such display screens various quick-reference legends 430 (FIG. 21) may be displayed that enables player to readily ascertain round and hole winners and losers.

Although not shown in the figures, the device and system 100 can also be configured in its many possible embodiments with the portable electronic programmable processor and storage memory unit 110 having sufficient memory and being programmed to receive, retain, search, edit, and display standardized and or editable text of rules for golf, which can be the U.S. Golf Association (“USGA”) rules, as well as any number of rules for one or more side games that many players enjoy, which can include Nassau, Skins, Greenies, and Wolf, and any number of custom games that many golfers enjoy in addition to playing the normal round or rounds of golf.

Although many possibly suitable and even preferred icon-type identification variations exist, and for purposes of further illustration of the principles of the instant invention, one quick-reference, icon-type identification system can include the use of: 1) a triangle 430 to define which player succeeded in one element of a side competition, 2) a square 435 to identify which player succeeded in a second element of such a side competition, and 3) a circle 440 to identify which user achieved a third element or objective of the particular competition. As can be seen, screen 420 illustrates one such icon-type identification system in connection with what is often referred to by golfers skilled in the rules of such side game competitions as “Bingo-Bango-Bongo.” A wide range of possible other such similarly capable screens and underlying functions adapted to display each side game competition that is incorporated into the memory 110 of the device and system 100. Additionally, any of the alternatives and variations of any of the preceding capabilities and functions are contemplated for use in connection with all of the preferred embodiments described in the context of the preferred golf score and display information device and system 100.

As the round of play continues, the user next tallies strokes for each hole at step 450 using what may be termed a score tally screen such as screen 455 of FIG. 22, which can also be arranged in a configuration that resembles the most common format for manual paper or cardboard score cards now in use at many golf course around the world. As with preceding embodiments, and the many noted modifications, variations, and alternatives thereto, the score tallying display of screen 455 is adapted for multimode horizontal and vertical scrolling hole by hole and or player by player, and or scrolling between front nine and back nine groups of holes, and or by groups 2, 3, 4, or 6 holes per scroll increment, and or scrolling by groups of players such as a group of 2 or 4 or 5 or 6 or 8 players at a time, using the various keys of the data entry assembly 130 or by touching the display 120 at an appropriate location in combination with and or in lieu of such use of the noted keys. Using either of the data entry methods and elements, the user and or the players may tally their scores for each hole. Although the scrolling capability described here illustrates scrollability in various discrete increments, many other possible configurations are also contemplated and can further included various types of zoom functions that can enlarge the information displayed so as to enable easier viewing for those needing visual aid capabilities for use of the device and system 100 without the need for magnification and or eyeglasses by the user.

For purposes of ease of data entry and stroke tracking, the display can incorporate a legend 460 that can be used with keystrokes and or touch screen functions to increment and decrement and enter and save strokes for any player on a given hole. More specifically, a user tallying scores may use various cursor arrow movement keys such keys 144, or touch the noted location of the screen 460 to increment a player's hole stroke count by selecting the plus symbol “+”, may decrement the count using the minus symbol “−”, and may enter, finalize, and or save the hole stroke count using the enter symbol “ [symbol] ”. Corresponding keys of the data entry assembly 130 may also be configured to effect the increment, decrement, and enter functions and can be adapted for such use in combination and or in lieu of the other noted capabilities. With this capability, the user may quickly and readily keep accurate stroke counts even while engaging in play during the round without unneeded complexities. Additional capabilities can include further time-saving features such as a single keystroke or screen touch function similar to the enter symbol “ [symbol] ” that is adapted to finalize stroke count scores for all players with a single operation, and without the need to individually finalize with respect to each player.

The instant invention is also directed to variations and modifications of any of the preceding embodiments wherein one or more symbolic, mnemonic, and other types of reference systems are incorporated to enable quick-reference viewing on a player-by-player, hole-by-hole basis, and to view various information for the current round that preferably includes player standing identifiers. With continued reference to the preceding figures, those having relevant skill and knowledge in the art may come to understand that the symbol and or icon-type identification system devised with respect to the viewing current round side game competition winners and losers as depicted by screen 420 shown in FIG. 21, can also be implemented in various ways on the score tally display screen 455. Additionally, player standing and status information can thereby be communicated on the facsimile golf score card representation 134 (FIGS. 1 and 22).

With continued specific reference to FIG. 22, in addition to the triangle, square, circle-type system already described, other types of such standing and status display systems can include numeric identifiers 465 that can be displayed peripherally about a specific player's stroke score for a given hole. In this system, each number, letter, and or symbol can represent one or more attributes that can include achievement of one or more objectives of any of the contemplated side game competitions. Another possible quick-reference standing identification system can include an icon-type system 470 that can incorporate symbols similar to those used on bowling score cards wherein slash “/”, circle “o”, cross or plus “+”, and “x” symbols are used to represent certain standing parameters such as the winner or winners of a greenies type side game competition for a given hole. Other symbols such as, for purposes of example without limitation, spirals or dots and squares 475 can function to represent yet other additional standing or status parameters.

It has also been found to effective to use various types of hashes 480 for similar quick-reference status and standing representation purposes. Additionally, various types of contrasting, emphasizing, and highlighting foreground and background coloration systems 485 can be employed to add yet more such quick-reference capabilities to the contemplated quick-reference systems. In this optional or preferable contrasting coloration system can be employed as depicted in connection with reference numeral 490 of FIG. 22 to quickly identify the current hole under play in the round for purposes assisting the user in accurately tallying strokes. In any of the contemplated quick-reference status and standing identification systems described, those skilled in the art should appreciate that various combinations of any or all of such systems can have added benefits to users that are responsible for tallying scores and communicating results to the other players on request.

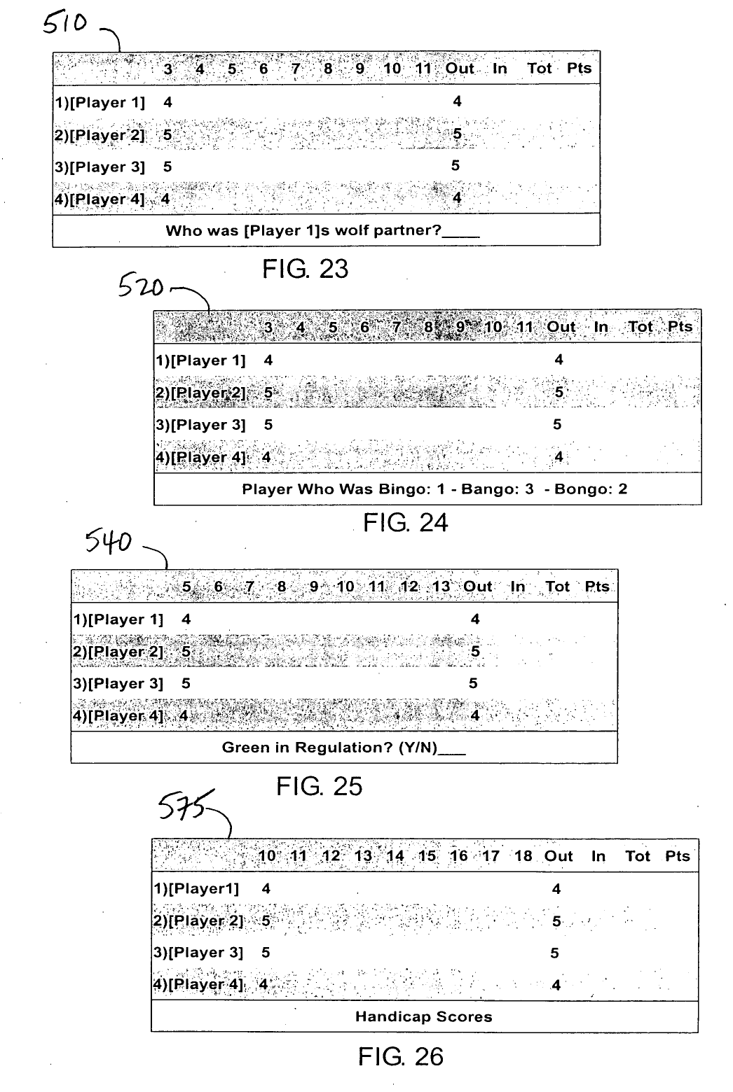

As scores are tallied during play of each hole, and after each hole is completed, players typically annotate the results of each of any side game competitions as they move to tee off at the next hole. With continued reference to FIG. 2B and step 500, one such capability for easily tracking such data is depicted in screen 510 of FIG. 23, wherein results for the often-favorite game of Wolf is shown querying to ascertain the Wolf's partner, if any, so that the appropriate points can be accumulated. Screen 520 of FIG. 24 depicts another variation to the previously described screen 420 of FIG. 21 wherein the Bingo, Bango, and Bongo players are identified for side game competition point allocation and tracking. Many other favorite games are similarly tallied for each hole or otherwise and can include such favorites as Bridge, Chairman, Greenies, Las Vegas, Low Ball—Low Total, Low Ball—High Ball, Nassau, Nines, Round Robin or 6, 6, and 6, Scramble, Shamble, Skins, Trifecta, Twosome Best Ball, 3 In 1, and 6-4-2-0 to name several.

Although the instant inventive golf score and display device and system 100 can be used simply for tracking a round of golf for one or more players, in addition to engaging in many types of side game competitions and hole-to-hole challenges, many players also prefer to track various play performance data and to keep statistics thereof, which can be useful for improving skills to reach higher levels of lower-handicap, scratch, and sub-par play capabilities. As contemplated in step 530 and depicted in screen 540 of FIG. 25, annotating whether the green was reached in regulation play is one such parameter or statistic. As those skilled in the art should appreciate, many other data items and statistics exists that are useful for post-round analysis, and which can include various types of drive, stroke, and putt distance data by club and tee and hole, number of 3, 4, 5 pars, number of holes-in-one, birdies, eagles, bogies, score totals by course, number of strokes left of and right of and on the fairway, bunker hits and sand saves, as well as many types of short-game and putt statistics. All of such data items can be entered into the device and system 100 and can be processed to compute estimated handicaps, and can be viewed for analysis of performance averages and comparative performance percentages.

Once play of a particular hole is completed, and as the players move the next hole to tee-off, or to the off-course putting green or driving range, the inventive device and system 100 enables additional challenges to be initiated at step 550, which additional types of challenges are limited only by the bounds of the imaginations of the players. At step 560, the device and system 100 either moves to the final score checking step 570, or continues functioning at step 450 to continue recording hole stroke tallies. If the round is completed, either by the circumstance of having completed 18 holes for a full round, or for any other reason (weather, time limits, nightfall, injury), then screen 575 can be viewed to enable error-checking of the scores for each player.

In the event that the final scores of the round are to be posted at step 580, then operation can move to step 600 wherein the player's can be authenticated again if needed or if not completed during initial set-up at step 340 (FIG. 2A) for the round just completed. Once the final scores have been corrected, if needed, and the players have been authenticated, if needed, then the scores can be posted by transferring the scores from the display 120 to the score record keeping system of the course, club, association, or organization having the authority to receive and track such scores. Even more preferably, the scores can be automatically and electronically communicated to the score keeping system that is adapted for receiving such information in this way. Once posting is completed, a confirmation number or other indicia can be entered into the device and system 100 if such is issued by the score receiving authority. The operation of the inventive device and system 100 then moves to step 610 to ascertain whether a new round is to be setup.

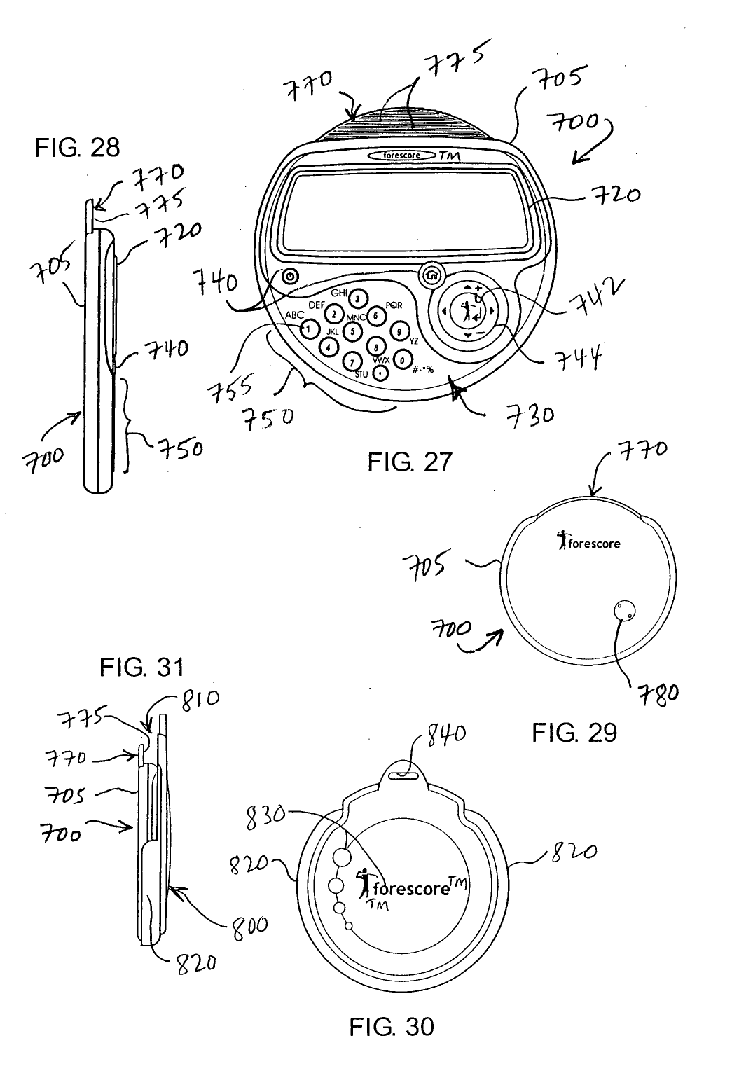

Although the instant golf score and display information device and system 100 has been illustrated in a detailed manner that enables those having skill in the art to practice the many inventive aspects of the invention, many possible specific and alternative preferred embodiments are contemplated thereby. Once such modified embodiment that can incorporate all and or any combination of the various features, elements, and capabilities of the previously illustrated preferred embodiments is further depicted in FIGS. 27 through 30. In FIG. 27, the inventive golf score and display information device is embodied in a modified version 700 that is adapted to have a substantially curvilinear, lightweight exterior body 705 that encloses the various components of the device and system 700.

In this alternative, the device and system 700 incorporates an internal electronic programmable processor and storage memory unit, similar or identical to those described elsewhere herein, and includes a display 720 and data entry assembly 730. Various function keys 740, 742, 744 and data entry keyboard elements 750 are also included and are configured to have the same capabilities already discussed in connection with the respective keys 140, 142, 144 and the data entry keyboard elements 150 of the device and system 100. Various of the keys function keys 740, 742, 744 can be further adapted with dedicated or specialized functions including a power-on-off-system reset function as well as a “home” function that can be adapted to operate to return the user either to a screen similar to screen 220 of FIG. 4 for initiating a new game, or to screen 455 of FIG. 22 for tallying stroke during a round.

For further improvements over previous devices, the instant keyboard elements 750 include fewer buttons for improved size capabilities and can preferably or optionally be configured in a number of ways to enable entry of alphanumeric text, numbers, and symbols using a number of innovative systems. One such system includes a specialized data entry mode of operation whereby pressing the numeric key 755 labeled with Arabic numeral “1” a single time enters the numeric digit. Quickly pressing the same key 755 a second time enters instead the letter “A”, and quickly a third time enters the letter “B”, and so on. In this way, all the letters of the English alphabet can be entered using only the 9 keys shown in FIG. 27, including key 755. Various other symbols can be entered using other keys in a similar manner.

In further improvements to the state of the art, the alternative device and system 700 can be further adapted to incorporate a clip lip 770 that can be formed with friction-enhancing and or interlocking ridges 775. The frictional or interlocking ridges 775 are preferably arranged as shown in a generally lateral orientation so that the clip lip 750 may be engaged beneath a standard golf score card clip or retainer (not shown) that is found on most golf carts (not shown) around the world on the steering wheel or on another part of the golf cart such as the dashboard, if any. By adjusting the height of the ridges 775, the device and system 700 can be configured to be securely retained under the golf cart score card clip or retainer as the players drive the cart about the course during a round of golf and during movement of the cart. The instant embodiment of the inventive device and system 700 may incorporate various internal rechargeable power sources and or may also incorporate replaceable power sources such as what are commonly referred to by the industry as button type batteries. In this latter configuration, as can be understood with reference to FIG. 29, the preferred device and system 700 would also preferably or optionally incorporate a removable battery compartment door 780 about the body 705 to contain such a replaceable button-type battery power source.

Even further additional embodiments are contemplated wherein alternatives such as the modified golf score and information display device and system 700 can be configured for compatibility with hard and or soft carrying cases such as the carrying case 800 depicted in FIGS. 30 and 31, which is adapted to retain the device and system 700 and to protect the display 720 and other elements from damage. Although many possible arrangements of carrying cases are well-suited for application in the context of the various preferred embodiments of the instant invention, the carrying case 800 can also be configured to receive and removably but frictionally retain the device and system 700 within a pocket and or recess 810 formed therein. Also, the case 800 may be adapted with retainer lips 820 that can further formed about and to further define the recess or pocket 810, to enhance the capability to carry and protect the device and system 700 from damage during periods of non-use and storage. Various decorative indicia 830 may also be added to further enhance the appearance of the various contemplated embodiments. Further, a carrying strap (not shown) slot 840 may be formed in the case 800 to enable attachment to a golf cart or golf bag (not shown).

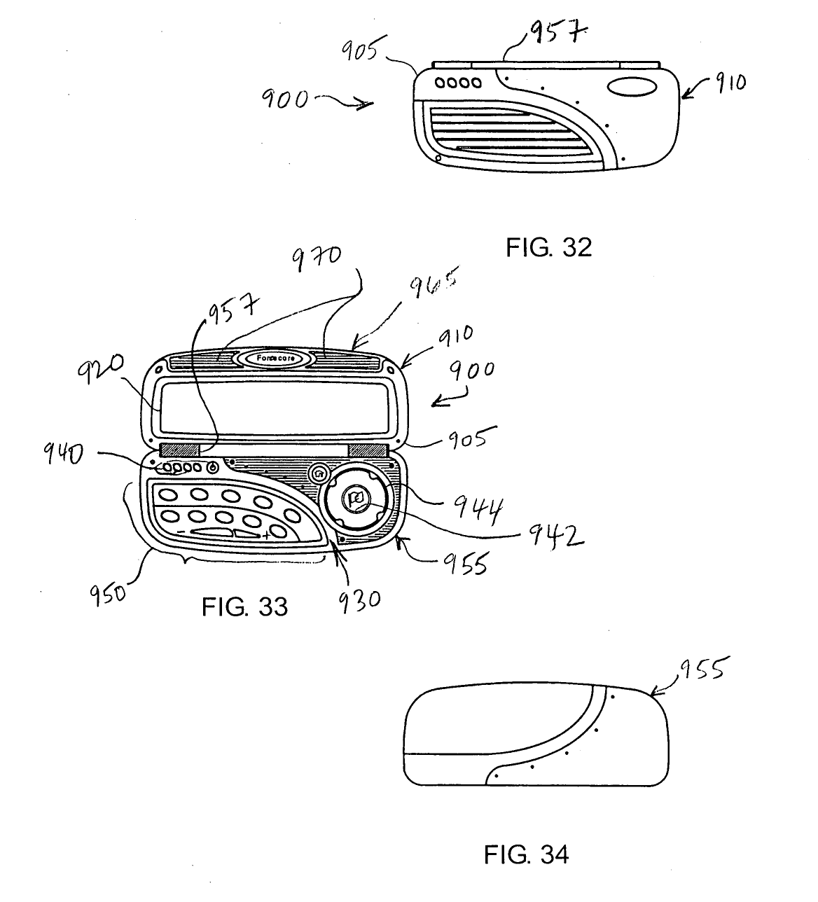

Referring next to FIGS. 32, 33, and 34, another modification of a preferred golf score display and information device and system 900 is illustrated. In this modification to any of the previously described preferred embodiments, and the various configurations and variations thereof, the device and system 900 incorporates the features, capabilities, and elements already discussed. Additionally, the modified device and system 900 also incorporates a flip-type body 905 with a upper portion 910 housing the a display 920 and a data entry assembly 930 containing various dedicated or specialized function keys 940, 942, 944 and data entry keyboard elements 950 about a lower portion 955 that connected by a hinge 957 to the upper portion 910. As with any of the preceding configurations and embodiments, the keys can be adapted to function in any of the ways already described. Additionally the alternatively arranged device and system 900 may be adapted to incorporate a clip lip 965 that may also further be formed with one or more frictional and or interlocking ridges 970 that can operate to securely retain the device and system 900 in the score card clip or retainer of the gold cart during a round of golf.

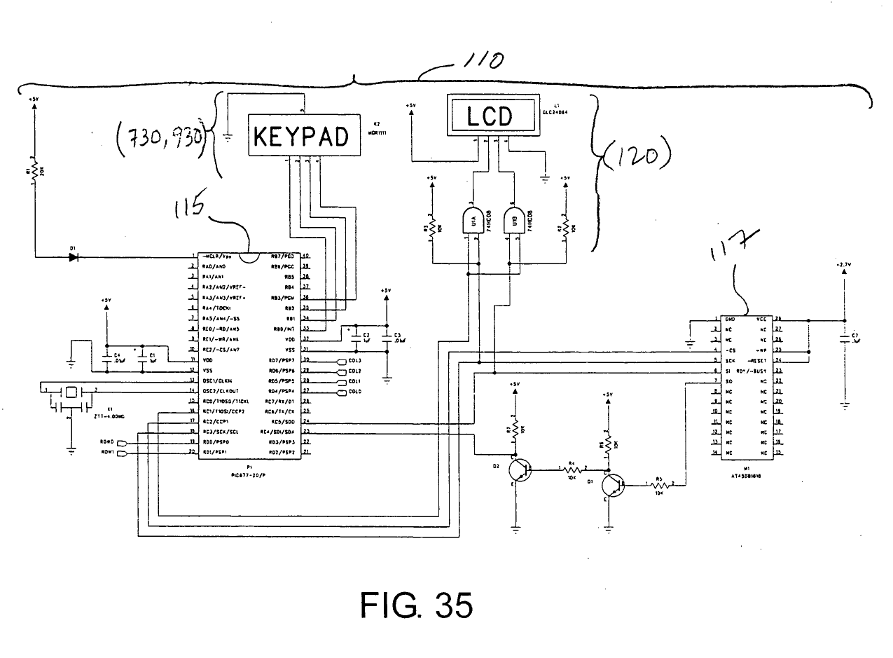

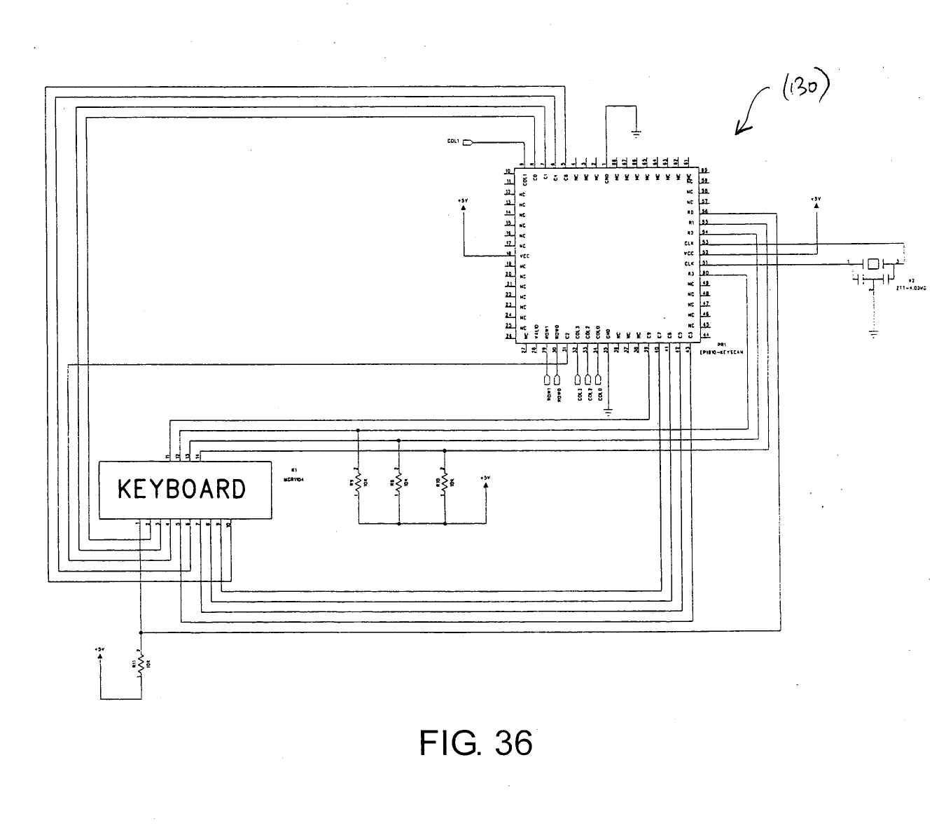

In any of the preceding preferred embodiments, a wide variety of possible components are available that can be used for purposes of the instant invention to establish a suitable portable and internal electronic programmable processor and storage memory unit, such as the processor and storage memory unit 110 described in connection with certain of the preceding embodiments and variations, alternatives, and medications thereto. With reference next to FIGS. 35 and 36, those having relevant skill in the relevant arts can come to understand that one such suitable portable and internal electronic programmable processor and storage memory unit 110 can incorporate what is commonly referred to in the industry as a PIC 877 single chip type computer system. In FIG. 35, various portions of the schematic have also been annotated with reference numerals contained within parentheses to generally identify those portions of the circuit diagram that correspond with the displays 120, 720, 920, and the data entry assemblies 130 (FIG. 36), 730, 930 (FIG. 35).

Many manufacturers and suppliers across the world offer a variety of such PIC 877 units and one possibly preferable configuration is illustrated in FIG. 35 in an electronic schematic that is compatible for use with many of the contemplated embodiments of the golf score and information device and systems 100, 700, 900 shown here. Many other equally preferable single-chip-type and other types of computers are also available and can include, for purposes of example without limitation, what are known in the electronics and computer industries as the Basic Stamp series of computers from Parallax, Inc., and the 8051 series computers from Intel Corp. and Philips Corp., and many variants thereof are available from a host of manufacturers around the world.

Additionally, while a wide variety of possible and prefer non-volatile memory storage options are equally suitable for purposes of the instant invention and the processor and memory unit 110, one particularly well-suited memory storage can include the Atmel Corp. 28-pin, 16M bit density, AT45DB161B DataFlash® Serial-Interface Flash memory chip identified generally with reference numeral 117 in FIG. 35. With reference again to FIGS. 35 and 36, those knowledgeable in the relevant arts should understand that the keypad type data entry assemblies 130, 730, 930 and the related circuits illustrated in these circuits are interchangeable depending upon the preferred configurations sought in practicing the various embodiments of the instant invention. Those having relevant skill in the art will also appreciate that many possible serial, Ethernet, parallel, infrared, wireless, radio, optical, and wired emitters and receivers and other means of communicating data, including the commonly used, universal serial bus (“USB”) components, to and from the device and systems 100, 700, 900 can be implemented in the context of the instant invention.

Numerous alterations, modifications, and variations of the preferred embodiments disclosed herein would be apparent to those skilled in the art and they are all contemplated to be within the spirit and scope of the instant invention, which is limited only by the following claims. For example, although specific embodiments have been described in detail, those with skill in the art can understand that the preceding embodiments and variations can be modified to incorporate various types of substitute and/or additional algorithms, rules, components, relative arrangement of components, features, elements, and dimensional configurations for compatibility with the wide variety of possible golf scoring, tallying, storing, and posting requirements, as well as for a variety of possibly desirable games, methods, environments, and carrying equipment (such as carts and bags and the like), and the many related accessories that are in wide spread use in the industry. Accordingly, even though only few such embodiments, alternatives, variations, and modifications of the present invention are described herein, it is to be understood that the practice of such additional modifications and variations and the equivalents thereof, are within the spirit and scope of the invention as defined in the following claims.

1. A golf score and information device, comprising:
a portable electronic programmable processor and memory unit that includes at least one display and a data entry assembly, at least one communication circuit, and at least one storage component;
wherein the display and the data entry assembly are adapted to cooperate to visually present information pertaining to any group of a plurality of holes of a golf course in a facsimile representation of a golf score card for the course;
the processor and memory unit being programmed to manipulate a plurality of items of the information including at least one set of golf course data including a slope and a course rating, at least two sets of golfer data that includes at least one golf game score for a plurality of holes, a handicap index and a scoring record; and
wherein the at least one communication circuit is adapted to selectively and automatically send and receive one or more data items of the plurality of scrollable information respectively to and from another golf score and information device.

2. The golf score and information device according to claim 1, wherein the portable electronic programmable processor and memory unit are a handheld portable data assistant.

3. The golf score and information device according to claim 1, wherein the processor and memory unit are programmed to periodically and automatically initiate a save point procedure that stores entered information into a non-volatile memory storage component to prevent data loss.

4. The golf score and information device according to claim 1, wherein the portable electronic programmable processor and memory unit are adapted with a unique security key code adapted whereby the golf score and information device can communicate via the at least one communication circuit only with another predesignated golf score and information device that can authenticate the unique security key.

5. The golf score and information device according to claim 4, wherein the unique security key is a resettable hardware component of the golf score and information device.

6. The golf score and information device according to claim 4, wherein the unique security key is a resettable software component of the golf score and information device.

7. The golf score and information device according to claim 4, wherein the unique security key is identified with a predetermined user of the golf score and information device.

8. The golf score and information device according to claim 1, wherein the processor and memory unit are programmed to process the course rating and the slope rating and the handicap index to establish an estimated player handicap and a running golf game score.

9. A golf score and information device, comprising:
a portable electronic programmable processor and memory unit that includes at least one display and a data entry assembly, at least one communication circuit, and at least one storage component;
wherein the display and the data entry assembly cooperate to visually present continuously scrollable information pertaining to any group of a plurality of holes of a golf course in a facsimile representation of a golf score card for the course;
the processor and memory unit being identified with a unique unit security key and being programmed to manipulate and communicate a plurality of items of the scrollable information, the items being selected from the group that includes at least one set of game point scores for at least five sets of golfer data that includes at least one golf game score, a table of points by hole by golfer, and a scoring record for each golfer; and
wherein the at least one communication circuit is adapted to selectively send and receive one or more data items of the plurality of information respectively to and from another golf score and information device.

10. The golf score and information device according to claim 9, wherein the portable electronic programmable processor and memory unit are a handheld portable data assistant.

11. The golf score and information device according to claim 9, wherein the processor and memory unit are programmed to periodically and automatically initiate a save point procedure that stores entered information into a non-volatile memory storage component to prevent data loss.

12. The golf score and information device according to claim 9, wherein the portable electronic programmable processor and memory unit are also adapted to received, store, process, and communicate a unique golfer security key whereby the golf score and information device can communicate via the at least one communication circuit only with another predesignated golf score and information device that can authenticate the unique unit and golfer security keys.

13. The golf score and information device according to claim 12, wherein the unique unit security key is a software component of the golf score and information device.

14. The golf score and information device according to claim 12, wherein the unique security key is identified with a predetermined user of the golf score and information device.

15. The golf score and information device according to claim 1 being adapted to be attached to a golf score card retainer of a golf cart, further comprising at least one grip clip formed with at least one ridge adapted to interlock with the retainer of the golf cart.

16. The golf score and information device according to claim 9, wherein the processor and memory unit are programmed to process the course rating and the slope rating and the handicap index to establish an estimated player handicap and a running golf game score.

17. A golf score and information device, comprising:
a portable electronic programmable processor and memory unit that includes at least one display and a data entry assembly, at least one communication circuit, and at least one storage component;
wherein the display and the data entry assembly are configured to visually present continuously scrollable information pertaining to any group of a plurality of holes of a golf course in a facsimile representation of a golf score card for the course;
the processor and memory unit being programmed to manipulate and communicate a plurality of items of the scrollable information, the items being selected from the group that includes at least one set of rules for side games, golf round data for at least four golfers, and a tournament scoring record;
wherein the at least one communication circuit is adapted to selectively send and receive one or more data items of the plurality of information respectively to and from another golf score and information device.

18. The golf score and information device according to claim 17, wherein the processor and memory unit are programmed to periodically and automatically initiate a save point procedure that stores entered information into a non-volatile memory storage component to prevent data loss.

19. The golf score and information device according to claim 17, wherein the portable electronic programmable processor and memory unit are adapted with at least one unique security key whereby the golf score and information device can communicate via the at least one communication circuit only with another predesignated golf score and information device that can authenticate the at least one unique security key.

20. The golf score and information device according to claim 19, wherein the at least one unique security key uniquely identifies the golf score and information device and at least one golfer using the device.

21. A golf score and information device, comprising:
a portable electronic programmable processor and memory unit that includes at least one display and a data entry assembly, and at least one storage component;
wherein the display and the data entry assembly cooperate to visually present continuously scrollable information pertaining to one or more players and any group of a plurality of holes of a golf course in a facsimile representation of a golf score card for the course; and
wherein the processor and memory unit are programmed to manipulate and display a plurality of items of the scrollable information including hole stroke scores, and to compute and display competition point totals for at least two side games for at least 4 players.

22. The golf score and information device, according to claim 21 wherein the portable electronic programmable processor and memory unit are further programmed to receive, store, manipulate, and compute and display scores and competition point totals for at least two side games for multiple players in a tournament of at least 5 players in real-time for players across a course that are concurrently playing on different holes.

23. A golf score and information device, comprising:
a portable electronic programmable processor and memory unit that includes at least one display and a data entry assembly, and at least one storage component;
wherein the display and the data entry assembly cooperate to visually present continuously scrollable information pertaining to one or more players and any group of a plurality of holes of a golf course in a facsimile representation of a golf score card for the course; and
wherein the processor and memory unit are programmed to receive, store, and retrieve a set of player preferences that include course, handicap, and side game competition preferences.

24. The golf score and information device, according to claim 23 wherein the processor and memory unit are programmed to receive, store, and retrieve the player preferences for at least 4 golfers prior to a round of golf to be scored on the device.

25. A golf score and information device, comprising:
a portable electronic programmable processor and memory unit that includes at least one display and a data entry assembly, and at least one storage component;
wherein the display and the data entry assembly cooperate to visually present continuously scrollable information pertaining to one or more players and any group of a plurality of holes of a golf course in a facsimile representation of a golf score card for the course; and
wherein the processor and memory unit are programmed to receive, store, and tally at least one side game competition and at least one hole-by-hole challenge competition between at least two players.

26. The golf score and information device, according to claim 24 wherein the processor and memory unit are programmed to receive, store, and tally at least one side game competition and at least one hole-by-hole challenge competition for at least 4 golfers during a round of golf to be scored on the device.

27. A golf score and information device, comprising:
a portable electronic programmable processor and memory unit that includes at least one display and a data entry assembly, and at least one storage component;
wherein the display and the data entry assembly are configured to visually present continuously scrollable information pertaining to any group of a plurality of holes of a golf course in a facsimile representation of a golf score card for the course;
the processor and memory unit being programmed to manipulate and communicate a plurality of items of the scrollable information that includes golf round data and side game competition data including stroke and competition point totals for at least four golfers.

28. The golf score and information device and system of claim 27 being adapted to be attached to a score card retainer of a golf cart, further comprising:
at least one clip lip adapted with ridges to interlock with the score card retainer of the golf cart.

29. A golf score and information device, comprising:
a portable electronic programmable processor and memory unit that includes at least one display and a data entry assembly, and at least one storage component;
wherein the display and the data entry assembly cooperate to visually present scrollable information pertaining to one or more players and any group of a plurality of holes of a golf course in a facsimile representation of a golf score card for the course; and
wherein the processor and memory unit are programmed to store, retrieve, and display one or more performance and skill improvement tips stored in the device for display to the one or more players.

30. The golf score and information device according to claim 29, wherein the processor and memory unit are further programmed to store and display performance statistics related to the one or more players and to correlate such statistics to the one or more performance and skill improvement tips stored in the device for display to the one or more players in the context of a hole to be played.

31. The golf score and information device according to claim 29, wherein the processor and memory unit are further programmed to store and display performance statistics related to the one or more players and to correlate such statistics to the one or more performance and skill improvement tips stored in the device for display to the one or more players in the context of one or more player skill improvement information preferences.

32. The golf score and information device according to claim 29, wherein the processor and memory unit are further programmed to store, retrieve, and display the one or more performance and skill improvement tips stored in the device for display to the one or more players in the context of one or more player skill improvement information preferences.

33. A golf score and information device, comprising:
a portable electronic programmable processor and memory unit that includes at least one display and a data entry assembly, and at least one storage component;
wherein the display and the data entry assembly are configured to visually present continuously scrollable information pertaining to any group of a plurality of holes of a golf course in a facsimile representation of a golf score card for the course;
the processor and memory unit being programmed to manipulate and communicate a plurality of items of the scrollable information that includes golf round data and at least one hole challenge competition including a tally capability for point totals for at least two golfers.
